(19) United States
(12) Patent Application Publication
(10) Pub. No.: US 2007/0217313 A1
(43) Pub. Date: Sep. 20, 2007

(54) Information Recording Medium, Information Recording Device and Method, and Record Controlling Computer Program

(76) Inventors: Keiji Katata, Saitama (JP); Tsuyoshi Namiki, Saitama (JP); Takeshi Koda, Saitama (JP); Masahiro Kato, Saitama (JP)

Correspondence Address: YOUNG & THOMPSON, 745 SOUTH 23RD STREET, 2ND FLOOR, ARLINGTON, VA, 22202, US

(21) Appl. No.: 11/597,508

(22) PCT Filed: May 23, 2005
(86) PCT No.: PCT/JP05/09384

§ 371 Date: Jan. 29, 2007

(30) Foreign Application Priority Data
May 27, 2004 (JP) 2004-157794

(51) Int. Cl. G11B 7/0045

(52) U.S. Cl. 369/59.25

(57) ABSTRACT

An information recording device is provided with a writing device for writing recording information in a first recording layer and a second recording layer of an information recording medium; an acquiring element for acquiring information relating to an offset quantity; and a calculating member for calculating a start position where the recording information can be recorded in the second recording layer, based on the acquired information. The information recording device is also provided with a control unit which controls the writing device to i) write the recording information in the first recording layer along a first recording track, and ii) write the recording information in the second recording layer along a second recording track from the calculated start position.

### TECHNICAL FIELD

The present invention relates to an information recording medium, such as a DVD and a Compact Disc (CD), an apparatus for and a method of recording information onto such an information recording medium, and a computer program for record control.

### BACKGROUND ART

For example, with respect to an information recording medium, such as a Compact Disc-Read Only Memory (CD-ROM), a Compact Disc-Recordable (CD-R), a DVD-ROM, a DVD-R, a DVD-R/W, and a DVD+R, an information recording medium, such as an optical disc, of a multi-layer type or of a dual-layer-type in which a plurality of recording layers are laminated or pasted on the same substrate has also been developed, as described in patent documents 1 and 2 and the like. Moreover, on an information recording apparatus, such as a DVD recorder, which records information onto such a dual-layer type optical disc, i.e. a two-layer type optical disc, laser light for recording is focused on a recording layer which is on the nearest side observed from the irradiation side of the laser light (i.e. on the closest side to an optical pickup) (wherein the recording layer is referred to as a “L0 layer”, as occasion demands). By this, the information recording apparatus records the information into the L0 layer in an irreversible change recording method by heat or in a rewritable method. Moreover, the laser light is focused on a recording layer which is on the back of the L0 layer observed from the irradiation side of the laser light (i.e. on the farthest side from the optical pickup), through the L0 layer and the like (wherein the recording layer is referred to as a “L1 layer”, as occasion demands). By this, the information recording apparatus records the information into the L1 layer in the irreversible change recording method by heat or in the rewritable method.

patent document 1: Japanese Patent Application Laid Open NO. 2000-311346

patent document 2: Japanese Patent Application Laid Open NO. 2001-23237

patent document 3: Japanese Patent Application Laid Open NO. 2001-329330

patent document 4: Japanese Patent Application Laid Open NO. 2001-329331

### DISCLOSURE OF INVENTION

### Subject to be Solved by the Invention

In the two-layer type optical disc, if the data is recorded into the L1 layer, the laser light is emitted to the L1 layer through the L0 layer. In this case, the record data may be or may not be recorded in the L0 layer through which the laser light is emitted. As described above, the recording state of the L0 layer is not necessarily unified or standardized, and the condition of the laser light with which the L1 layer is irradiated changes depending on the recording state of the L0 layer. Thus, the inventors of the present invention also suggests such a method that the record data is properly recorded into the L1 layer by making the L0 layer in a recorded condition in advance.

However, in the production process of the two-layer type optical disc, such as the DVD-ROM and the DVD-R/RW, melted polycarbonate resin is molded by using a stampa disc (hereinafter referred to as a “stampa”), to thereby form the L0 layer and the L1 layer separately, and the substrates of the L0 layer and the L1 layer are pasted lastly. Thus, there is a possibility that an error in pasting may cause an eccentricity in the L0 layer and the L1 layer. Alternatively, since the L0 layer and the L1 layer are formed by using different stampas, that may cause deviation in a track pitch in each of the recording layers. For these reasons, a shift or displacement occurs between a position of one recording area of the L0 layer and a position of another recording area of the L1 layer that corresponds to the one recording area of the L0 layer, which is indicated by position information, such as a pre-format address. Thus, there is such a technical problem that the laser light is not always emitted to the another recording area of the L1 layer, through the one recording area, which is in the recorded condition, of the L0 layer. There is also the following problem. If a recordable recording area is limited in the L1 layer in order to remove the influence of a boundary area between the recording area which is in an unrecorded condition of the L0 layer and the recording area which is in the recorded condition of the L0 layer, only a recording capacity corresponding to this limited recording area, i.e. the recording area in which the recording is. F forbidden, will be a waste.

Alternatively, there is the following problem. The eccentricity caused by the error in pasting in the L0 layer and the L1 layer or the like, causes a large error in position between a desired address and an actually accessed position on the two-layer type optical disc, and increases a search time at the time of a layer-to-layer jump (a so-called jump performance), as compared to the case of a single-layer type optical disc. This causes the phenomenon that the reproduction between two layers is interrupted, or the similar phenomenon.

It is therefore an object of the present invention to provide an information recording medium which allows the proper recording of information even if it has a plurality of recording layers, for example, as well as an information recording apparatus and an information recording method, and a computer program which makes a computer function as the information recording apparatus.

### MEANS FOR SOLVING THE SUBJECT

(Information Recording Medium)

The information recording medium of the present invention will be explained hereinafter.

The above object of the present invention can be achieved by an information recording medium provided with: a first recording layer in a disc shape in which a first recording track is formed to record at least record information; and a second recording layer in a disc shape in which a second recording track is formed to record the record information through the first recording layer, at least one of the first and second recording layer provided with a management area in which information as for an offset amount is recorded, the offset amount indicating a relative shift in a radial direction between the first and second recording layers or between the first and second recording tracks.

According to the information recording medium of the present invention, it is, for example, a DVD or an optical disc of a two-layer type or a multiple-layer type, in which the first and second recording layers are laminated on one surface of a disc-shaped substrate. In the first recording layer, the record information, such as audio information, video information, or content information, can be recorded along the first recording track which is provided with a groove (a guiding groove). In the second recording layer, the record information, such as audio information, video information, or content information, can be recorded along the second recording track which is provided with a groove (a guiding groove). By such construction, the substrate, the first recording layer, and the second recording layer, are irradiated with laser light for recording or reproduction, in this order.

More specifically, particularly, the first recording track may be directed from one to the other side, out of the inner circumferential side and the outer circumferential side of the above-described substrate. The second recording track may be directed from the one to the other side, as with the first recording track. Namely, on the two-layer type or multiple-layer type information recording medium, it is possible to perform continuous recording in a “parallel manner” in which the recording tracks are directed in the same direction between the two recording layers. In the “parallel manner”, if the recording or reproduction is ended in the first recording layer, an optical pickup that is on the most outer circumference of the optical disc needs to be displaced again to the most inner circumference when the recording or reproduction is started in the second recording layer. Thus, as compared to an “opposite manner”, it takes more time by that much to change from the L0 layer to the L1 layer. Alternatively, the first recording track may be directed from one to the other side, out of the inner circumferential side and the outer circumferential side of the above-described substrate. As opposed to this, the second recording track may be directed from the other to the one side. Namely, on the two-layer type or multiple-layer type information recording medium, it is possible to perform continuous recording in the “opposite manner” in which the recording tracks are directed in the opposite directions between the two recording layers. Therefore, if the recording is continuously performed from the end edge of the first recording layer, i.e. an edge on the other side of the first recording layer, such as an outer circumferential end portion of the first recording layer, to the start edge of the second recording layer, i.e. an edge on the other side of the second recording layer, such as an outer circumferential end portion of the second recording layer, it is hardly necessary or not necessary at all to change the irradiation position of the laser light in the substrate surface, in the radial direction, in changing the recording layers which is the object of recording processing or reproduction processing associated with the information. This allows the quick layer-to-layer jump (i.e. a layer-to-layer changing operation). This does not need a special buffer function to change the recording layers, in recording the continuous record information, such as a movie, for example. Moreover, this facilitates the reproduction without a stop, so that it is extremely useful in practice.

Particularly, according to the information recording medium of the present invention, at least one of the first and second recording layers is provided with the management area in which the offset amount is recorded. Here, the “offset amount” is a physical quantity which indicates the relative shift in the radial direction between the first and second recording layers or between the first and second recording tracks. The offset amount may be shown by the number of sectors or the number of ECC (Error Correcting Code) blocks, which are the predetermined unit of an address, or may be shown by the length (μm) in the radial direction of the optical disc and then be possibly converted to the number of sectors and the number of ECC blocks.

Therefore, it is possible to perform the proper recording operation in the first and second recording layers, on the basis of the offset amount, by that an information recording apparatus described later obtains and refers to the offset amount.

In one aspect of the information recording medium of the present invention, information as for a first offset amount is recorded in the management area as the offset amount, the first offset amount indicating a difference in radial positions of a first place which is a reference of a pre-formatted address in the first recording track (e.g. a circumference with an address of “30000h” in the L0 layer) and a second place which is a reference of the pre-formatted address in the second recording track (e.g. a circumference with an address of “30000h” in the L1 layer).

According to this aspect, the first offset amount is recorded in the management area. Here, the “first offset amount” is a difference in the radial positions of (i) a place which is the reference of the pre-format address in the L0 layer (e.g. a circumference with a sector number of “30000h” in the L0 layer) and (ii) a place which is the reference of the pre-format address in the L1 layer (e.g. a circumference with a sector number of “30000h” in the L1 layer). Moreover, the first offset amount may be constructed by considering the extent of the eccentricity (which is a “second offset amount” described later) caused by the error in pasting in the L0 layer and the L1 layer. More specifically, for example, half of the extent of the eccentricity is added to or is subtracted from the first offset amount. The first offset amount may be shown by the number of sectors or the number of ECC blocks, which are the predetermined unit of the address, or may be shown by the length (μm) in the radial direction of the optical disc and then possibly converted to the number of sectors and the number of ECC blocks.

Therefore, it is possible to perform the proper recording operation in the first and second recording layers, on the basis of the first offset amount, by that the information recording apparatus described later obtains and refers to the first offset amount.

In another aspect of the information recording medium of the present invention, information as for a second offset amount is recorded in the management area as the offset amount, the second offset amount indicating extent of eccentricity caused by an error in pasting in the first recording layer and the second recording layer.

According to this aspect, the second offset amount is recorded in the management area. Here, the “second offset amount” is the extent of the eccentricity caused by the error in pasting in the first recording layer and the second recording layer. More specifically, this eccentricity is caused by pasting the first layer and the second layer, a little away from each other, due to the accuracy of a pasting apparatus in the reproduction of the two-layer type optical disc which has a pasted structure. The second offset amount may be shown by the number of sectors or the number of ECC blocks, which are the predetermined unit of the address, or may be shown by the length (μm) in the radial direction of the optical disc and then be possibly converted to the number of sectors and the number of ECC blocks.

Therefore, it is possible to perform the proper recording operation in the first and second recording layers, on the basis of the second offset amount, by that the information recording apparatus described later obtains and refers to the second offset amount.

In another aspect of the information recording medium of the present invention, information as for a third offset amount is recorded in the management area as the offset amount, the third offset amount indicating a difference in radial positions of a most outer circumferential position of a recording area of the second recording layer and a most outer circumferential position of a recording area of the first recording layer, the difference being caused by that a track pitch varies in the first recording layer and the second recording layer.

According to this aspect, the third offset amount is recorded in the management area. Here, the “third offset amount” is the difference in the radial positions of the most outer circumferential position of a recording area of the second recording layer and the most outer circumferential position of a recording area of the first recording layer, and the difference is caused by that a track pitch varies in the first recording layer and the second recording layer. Incidentally, as with the first and second offset amounts, the third offset amount may be shown by the length (μm) in the radial direction of the optical disc and then be possibly converted to the number of sectors and the number of ECC blocks. Alternatively, it may be directly shown by the number of sectors and the number of ECC blocks, which are the predetermined unit of the address.

Therefore, it is possible to perform the proper recording operation in the first and second recording layers, on the basis of the third offset amount, by that the information recording apparatus described later obtains and refers to the third offset amount.

(Information Recording Apparatus)

The information recording apparatuses of the present invention will be explained hereinafter.

The above object of the present invention can be also achieved by a first information recording apparatus for recording record information onto the above-described information recording medium of the present invention (including its various aspects), the information recording apparatus provided with: a writing device capable of writing the record information into the first recording layer and the second recording layer; an obtaining device for obtaining the information as for the offset amount; a calculating device for calculating a start position from which the record information can be recorded, in the second recording layer, on the basis of the obtained information; and a controlling device for controlling the writing device (i) to write the record information into the first recording layer along the first recording track and (ii) to write the record information into the second recording layer along the second recording track from the calculated start position.

According to the first information recording apparatus of the present invention, at first, the calculating device, such as a Central Processing Unit (CPU) of a drive disc or a host computer, calculates the start position from which the record information can be recorded, in the second recording layer, in the case where one portion of the record information is written into the first recording layer along the first recording track, and in the case where another portion of the recording information is written along the second recording track, on the basis of the information obtained by the obtaining device, before the recording operation.

Then, under the control of the controlling device, such as a CPU, the writing device, such as an optical pickup, for recording the record information into the first and second recording layers, (i) writes one portion of the record information into the first recording layer along the first recording track and (ii) writes another portion of the record information into the second recording layer along the second recording track from the calculated start position.

As described above, in the recording operation by the first information recording apparatus of the present invention, it is possible to calculate the start position in the second recording layer on the basis of the offset amount, and it is possible to perform the recording operation from the calculated start position, by that the information recording apparatus obtains and refers to the offset amount. Namely, by adding at least only the first offset amount to or subtracting it from the pre-formatted address system in the second recording layer, the recording operation can be performed under a newly defined address system in the second recording layer based on the pre-formatted address system in the first recording layer.

As described above, according to the recording operation by the first information recording apparatus of the present invention, a search time at the time of the layer-to-layer jump or change (a so-called jump performance) is hardly influenced or not influenced at all by the error between the desired address and the actually accessed position, which is caused by the presence of the offset amount, for example, on the information recording medium, such as the two-layer type optical disc. Namely, according to the recording operation of the present invention, the information recording apparatus can access the desired address without delay, under the newly defined physical address system in the second recording layer, based on the pre-formatted address system in the first recording layer. Thus, the information recording apparatus hardly delays or does not delay the search time at the time of layer-to-layer jump at all.

Moreover, according to the recording operation by the first information recording apparatus of the present invention, if the record data is alternately recorded in the first recording layer and the second recording layer, when the record data is recorded in the vicinity of a recording start position or a recording end position on the most inner circumferential side or the most outer circumferential side of the recording area in the second recording layer after the recording of the record data in the first recording layer, it is possible to control the recording operation such that the laser light for recording goes through the first recording layer in the recorded condition, without the influence by the error in position caused by the eccentricity in the first recording layer and the second recording layer or the like. Namely, it is possible to record the record data into the second recording layer by the laser light emitted through the first recording layer in which the record data is already recorded. Thus, it is possible to properly record the data in the all of the recording areas including the vicinity of the recording start position or the recording end position on the most inner circumferential side or the most outer circumferential side of the second recording layer, with the optimum recording laser power obtained if the record data is recorded into the second recording layer through the first recording layer which is in the recorded condition. As a result, it is possible to stabilize reproduction features (e.g. an asymmetry value, a jitter value, degree of modulation, a reproduction error rate, and the like) and obtain good reproduction features even in the case of the reproduction of the record data, which is recorded in the recording area in the second recording layer. In addition, the recording laser power is not necessarily changed, and the record data may be recorded under the newly defined address system, so that there is such an advantage that the recording operation itself is simplified. Moreover, there is also such an advantage that it is not necessary to limit the recording area in which the information can be recorded. Moreover, there is also such an advantage that it is not necessary to provide a buffer area, such as a lead-in area, in the first recording area corresponding to the most inner circumferential side of the recording area in the second recording area in which a boundary area between the recorded recording area and the unrecorded recording area of the first recording layer influences the recording/reproduction features of the second recording layer. Moreover there is such advantage that it is only necessary to consider (i) the error in pasting and (ii) the deviation in the track pitch or the linear velocity, in the data area in the second layer, for example.

The above object of the present invention can be also achieved by a second information recording apparatus for recording record information onto the above-described information recording medium of the present invention (including its various aspects), the information recording apparatus provided with: a writing device capable of writing the record information into the first recording layer and the second recording layer; a detecting device for detecting the offset amount; and a controlling device for controlling the writing device to write information as for the detected offset amount into the management area along the first or second recording track.

According to the second information recording apparatus of the present invention, at first, under the control of the controlling device, such as a CPU, the detecting device, such as an optical pickup, detects the offset amount.

Then, under the control of the controlling device, such as a CPU, the writing device, such as an optical pickup, for recording the record information into the first and second recording layers, writes the information as for the detected offset amount, into the management area in at least one of the first recording layer and the second recording layer, along with the first or second recording track. Specifically, for example, with respect to the two-layer type DVD+R optical disc or the like, the information recording apparatus which performs the recording operation at first, performs the layer-to-layer jump and detects the offset amount between the two layers, in recording various control information and management information in one portion of the management area in the first recording layer. Then, the information recording apparatus records the information as for the detected offset amount into a Session Disc Control Block (SDCB) described later, together with the various control information and the like. Incidentally, the SDCB is one portion of an area in which information for controlling the recording of a session corresponding to a border in the incremental write of a DVD-R is recorded.

Therefore, for example, since the offset amount which is specific on the two-layer type information recording medium is recorded in the management area on each information recording medium, the information as for the recorded offset amount is read and obtained by the information recording apparatus. Thus, it is possible to calculate the start position in the second recording layer, and perform the recording operation more simply from the start position. In addition, it is possible to improve the reliability of the offset amount recorded on the information recording medium by comparing it with the detected offset amount in a different procedure by the information recording apparatus.

In one aspect of the second information recording apparatus of the present invention, it is further provided with a calculating device for calculating a start position from which the record information can be recorded, in the second recording layer, on the basis of the detected offset amount, the controlling device controlling the writing device (i) to write the record information into the first recording layer along the first recording track and (ii) to write the record information into the second recording layer along the second recording track from the calculated start position.

According to this aspect, as compared to the case where the recording operation is performed on the basis of the offset amount recorded on the information recording medium, even if a series of recording operations is performed on a plurality of information recording apparatuses, the optimum and accurate offset amount is individually detected by each of the plurality of information recording apparatuses. On the detected optimum and accurate offset amount, it is possible to perform the recording operation in the second recording layer.

In addition, it is possible to obtain the same effect as that of the first information recording apparatus of the present invention described above.

In another aspect of the first information recording apparatus of the present invention, the information recording medium is further provided with a data area in which the record information can be recorded from a first start position to a first end position, in at least one of the first and second recording areas, the calculating device calculates the first start position and the first end position, on the basis of the obtained offset amount, and the controlling device controls the writing device to write the record information from the first start position to the first end position, along the first or second recording track.

According to this aspect, it is possible to properly form the data area in which the record information can be recorded from the first start position to the first end position, in at least one of the first and second recording areas, on the basis of the obtained offset amount. Here, the “first start position” is a recordable start position in the data area. In the same manner, the “first end position” is a recordable end position in the data area.

In another aspect of the second information recording apparatus of the present invention, the information recording medium is further provided with a data area in which the record information can be recorded from a first start position to a first end position, in at least one of the first and second recording areas, the calculating device calculates the first start position and the first end position, on the basis of the detected offset amount, and the controlling device controls the writing device to write the record information from the first start position to the first end position, along the first or second recording track.

According to this aspect, it is possible to properly form the data area, in at least one of the first and second recording areas, on the basis of the detected offset amount.

In this aspect, the calculating device may calculate the first start position such that a most inner circumferential position of the data area in the second recording layer is positioned relatively on an outer circumferential side, only by at least the offset amount, from a most inner circumferential position of the data area in the first recording layer.

By such construction, it is possible to calculate the first start position in the second recording layer on the offset amount, and it is possible to perform the recording operation from the first start position.

As described above, when the record data is recorded in the vicinity of the most inner circumferential position of the recording area in the second recording layer, it is possible to control the recording operation such that the laser light for recording goes through the first recording layer in the recorded condition, without the influence by the error in position caused by the eccentricity in the first recording layer and the second recording layer or the like.

In this aspect, the calculating device may calculate the first start position such that a most outer circumferential position of the data area in the second recording layer is positioned relatively on an inner circumferential side, only by at least the offset amount, from a most outer circumferential position of the data area in the first recording layer.

By such construction, when the record data is recorded in the vicinity of the most outer circumferential position of the recording area in the second recording layer, it is possible to control the recording operation such that the laser light for recording goes through the first recording layer in the recorded condition, without the influence by the error in position caused by the eccentricity in the first recording layer and the second recording layer or the like.

Moreover, the first start position in the second recording layer is calculated on the third offset amount as the offset amount, and the recording operation is performed from the first start position. Thus, when the record data is recorded in the vicinity of the most outer circumferential position of the recording area in the second recording layer, it is possible to control the recording operation such that the laser light for recording goes through the first recording layer in the recorded condition, without the influence by the error in position caused by that the track pitch varies in the first recording layer and in the second recording layer or the like.

In another aspect of the first information recording apparatus of the present invention, the information recording medium is further provided with a lead-out area in addition to or in place of a lead-in area in which a buffer data as being at least one portion of the record information can be recorded from a second start position to a second end position, in at least one of the first and second recording areas, the calculating device calculates the second start position and the second end position, on the basis of the obtained offset amount, as the start position, and the controlling device controls the writing device to write the buffer data from the second start position to the second end position, along the first or second recording track, in response to a finalize instruction with respect to the information recording medium.

According to this aspect, it is possible to properly form the lead-out area in addition to or in place of the lead-in area in which the buffer data as being at least one portion of the record information can be recorded from the second start position to the second end position, in at least one of the first and second recording areas, on the basis of the obtained offset amount. Here, the “second start position” is a recordable start position in the lead-out area in addition to or in place of the lead-in area. In the same manner, the “second end position” is a recordable end position in the lead-out area in addition to or in place of the lead-in area.

In another aspect of the second information recording apparatus of the present invention, the information recording medium is further provided with a lead-out area in addition to or in place of a lead-in area in which a buffer data as being at least one portion of the record information can be recorded from a second start position to a second end position, in at least one of the first and second recording areas, the calculating device calculates the second start position and the second end position, on the basis of the detected offset amount, as the start position, and the controlling device controls the writing device to write the buffer data from the second start position to the second end position, along the first or second recording track, in response to a finalize instruction with respect to the information recording medium.

According to this aspect, it is possible to properly form the lead-out area in addition to or in place of the lead-in area, in at least one of the first and second recording areas, on the basis of the detected offset amount.

In another aspect of the first information recording apparatus of the present invention, the information recording medium is further provided with a calibration area in which data for trial writing as being at least one portion of the record information can be recorded from a third start position to a third end position, in at least one of the first and second recording areas, in order to obtain an optimum recording power of laser light for recording, the calculating device calculates the third start position and the third end position, on the basis of the obtained offset amount, as the start position, and the controlling device controls the writing device to write the data for trial writing from the third start position to the third end position, along the first or second recording track, in response to an instruction for obtaining the optimum recording laser power with respect to the information recording medium.

According to this aspect, it is possible to properly form the calibration area in which the data for trial writing as being at least one portion of the record information can be recorded from the third start position to the third end position, in at least one of the first and second recording areas, on the basis of the obtained offset amount. Here, the “third start position” is a recordable start position in the calibration area. In the same manner, the “third end position” is a recordable end position in the calibration area.

In another aspect of the second information recording apparatus of the present invention, the information recording medium is further provided with a calibration area in which data for trial writing as being at least one portion of the record information can be recorded from a third start position to a third end position, in at least one of the first and second recording areas, in order to obtain an optimum recording power of laser light for recording, the calculating device calculates the third start position and the third end position, on the basis of the detected offset amount, as the start position, and the controlling device controls the writing device to write the data for trial writing from the third start position to the third end position, along the first or second recording track, in response to an instruction for obtaining the optimum recording laser power with respect to the information recording medium.

According to this aspect, it is possible to properly form the calibration area, in at least one of the first and second recording areas, on the basis of the detected offset amount.

In another aspect of the first and second information recording apparatus of the present invention, the controlling device controls the writing device, not to write the record information into a recording area of the second recording layer corresponding to a vicinity of a boundary between a recorded area and an unrecorded area of the first recording layer.

According to this aspect, when the record data is recorded in the recording area in the second recording layer, it is possible to control the recording operation such that the laser light for recording goes through the first recording layer in the recorded condition, without the influence by the error in position caused by the eccentricity in the first recording layer and the second recording layer or the like.

(Information Recording Method)

The information recording methods of the present invention will be explained hereinafter.

The above object of the present invention can be also achieved by a first information recording method on an information recording apparatus capable of recording record information onto the above-described information recording medium of the present invention (including its various aspects), the information recording method provided with: an obtaining process of obtaining the information as for the offset amount; a calculating process of calculating a start position from which the record information can be recorded, in the second recording layer, on the basis of the obtained information; and a writing process of writing the record information (i) into the first recording layer along the first recording track and (ii) into the second recording layer along the second recording track from the calculated start position.

According to the first information recording method of the present invention, as in the case of the first information recording apparatus of the present invention, it passes through the obtaining process, the calculating process, and the writing process, under the control of the controlling process. Then, the search time at the time of the layer-to-layer jump or change (a so-called jump performance) is hardly influenced or not influenced at all by the error between the desired address and the actually accessed position, which is caused by the presence of the offset amount, such as the first offset amount, on the information recording medium, such as the two-layer type optical disc.

Moreover, for example, if the record data is alternately recorded in the first recording layer and the second recording layer, when the record data is recorded in the vicinity of the recording start position or the recording end position on the most inner circumferential side or the most outer circumferential side of the recording area in the second recording layer after the recording of the record data in the first recording layer, it is possible to control the recording operation such that the laser light for recording goes through the first recording layer in the recorded condition, without the influence by the error in position caused by the eccentricity in the first recording layer and the second recording layer or the like. As a result, it is possible to properly record the data in the all of the recording areas including the vicinity of the recording start position or the recording end position on the most inner circumferential side or the most outer circumferential side of the second recording layer, with the optimum recording laser power obtained if the record data is recorded into the second recording layer through the first recording layer which is in the recorded condition, as in the case of the first information recording apparatus of the present invention. As a result, it is possible to stabilize the reproduction features and obtain the good reproduction features even in the case of the reproduction of the record data, which is recorded in the recording area in the second recording layer.

Incidentally, in response to the various aspects of the first information recording apparatus of the present invention described above, the first information recording method of the present invention can adopt various aspects.

The above object of the present invention can be also achieved by a second information recording method on an information recording apparatus capable of recording record information onto the above-described information recording medium of the present invention (including its various aspects), the information recording method provided with: a detecting process of detecting the offset amount; and a writing process of writing information as for the detected offset amount into the management area along the first or second recording track.

According to the second information recording method of the present invention, as in the case of the second information recording apparatus, the offset amount is detected through the detecting process under the controlling process.

Then, for example, under the control of the controlling device, such as a CPU, the writing process of writing the record information into the first and second recording layers, writes the information as for the detected offset amount, into the management area along the first or second recording track, in at least one of the first and second recording layers.

Therefore, for example, since the offset amount which is specific on the two-layer type information recording medium is recorded in the management area on each information recording medium, the information as for the recorded offset amount is read and obtained by the information recording apparatus. Thus, it is possible to calculate the start position in the second recording layer, and perform the recording operation more simply from the start position. In addition, it is possible to improve the reliability of the offset amount recorded on the information recording medium by comparing it with the detected offset amount in a different procedure by the information recording apparatus.

(Computer Program)

The above object of the present invention can be also achieved by a first computer program of instructions for tangibly embodying a program of instructions executable by a computer provided in the first information recording apparatus of the present invention (including its various aspects), to make the computer function as at least one portion of the writing device, the obtaining device, the calculating device, and the controlling device.

According to the first computer program of the present invention, the above-described first information recording apparatus of the present invention can be relatively easily realized as a computer reads and executes the first computer program from a program storage device, such as a ROM, a CD-ROM, a DVD-ROM, and a hard disk, or as it executes the first computer program after downloading the program through a communication device.

Incidentally, in response to the various aspects of the first information recording apparatus of the present invention described above, the first computer program of the present invention can adopt various aspects.

The above object of the present invention can be also achieved by a second computer program of instructions for tangibly embodying a program of instructions executable by a computer provided in the second information recording apparatus of the present invention (including its various aspects), to make the computer function as at least one portion of the writing device, the detecting device, and the controlling device.

According to the second computer program of the present invention, the above-described second information recording apparatus of the present invention can be relatively easily realized as a computer reads and executes the second computer program from a program storage device, such as a ROM, a CD-ROM, a DVD-ROM, and a hard disk, or as it executes the second computer program after downloading the program through a communication device.

Incidentally, in response to the various aspects of the above-mentioned second information recording apparatus of the present invention, the second computer program of the present invention can also adopt various aspects.

The above object of the present invention can be also achieved by a first computer program product in a computer-readable medium for tangibly embodying a program of instructions executable by a computer provided in the above-mentioned first information recording apparatus of the present invention (including its various aspects), to make the computer function as at least one portion of the writing device, the obtaining device, the calculating device, and the controlling device.

According to the first computer program product of the present invention, at least one portion of the writing device, the obtaining device, the calculating device, and the controlling device of the present invention described above c an be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as at least one portion of the writing device, the obtaining device, the calculating device, and the controlling device of the present invention described above.

The above object of the present invention can be also achieved by a second computer program product in a computer-readable medium for tangibly embodying a program of instructions executable by a computer provided in the above-mentioned second information recording apparatus of the present invention (including its various aspects), to make the computer function as at least one portion of the writing device, the detecting device, and the controlling device.

According to the second computer program product of the present invention, at least one portion of the writing device, the detecting device, and the controlling device of the present invention described above can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as at least one portion of the writing device, the detecting device, and the controlling device of the present invention described above.

These effects and other advantages of the present invention will become more apparent from the following embodiments.

As explained above, according to the information recording medium of the present invention, it is provided with: the first recording layer; the second recording layer; and the management area in which the offset amount is recorded. Therefore, it is possible to perform the proper recording operation in the first and second recording layers, on the basis of the offset amount, by the information recording apparatus described later.

Moreover, according to the first information recording apparatus of the present invention, it is provided with: the writing device; the obtaining device; the calculating device; and the controlling device. According to the first information recording method of the present invention, it is provided with: the obtaining process; the calculating process; and the controlling process. According to the first computer program of the present invention, a computer is made function as the first information recording apparatus. Thus, the search time at the time of the layer-to-layer jump or change (a so-called jump performance) is hardly influenced or not influenced at all by the error between the desired address and the actually accessed position, which is caused by the presence of the offset amount, for example, on the information recording medium, such as the two-layer type optical disc. Moreover, it is possible to properly record the data in the all of the recording areas including the vicinity of the recording start position or the recording end position on the most inner circumferential side or the most outer circumferential side of the second recording layer, with the optimum recording laser power obtained if the record data is recorded into the second recording layer through the first recording layer which is in the recorded condition. Alternatively, according to the second information recording apparatus of the present invention, it is provided with: the writing device; the detecting device; and the controlling device. According to the second information recording method of the present invention, it is provided with: the detecting process; and the controlling process. According to the second computer program of the present invention, a computer is made function as the second information recording apparatus. Thus, the information as for the offset amount can be recorded.

### BRIEF DESCRIPTION OF DRAWINGS

FIG. 1 are a substantial plan view showing the basic structure of an optical disc having a plurality of recording areas in an embodiment of an information recording medium of the present invention (FIG. 1(a)), and a schematic cross sectional view of the optical disc and a corresponding conceptual diagram showing a recording area structure in the radial direction (FIG. 1(b)).

FIG. 2 is a conceptual graph schematically showing the data structure of the optical disc of a two-layer type in the embodiment of the information recording medium of the present invention, a sector number of sectors constituting an ECC block in the recording area of the optical disc, and a recording or reproducing method in a parallel manner of the optical disc.

FIG. 3 is a conceptual graph schematically showing the data structure of the two-layer type optical disc in the embodiment of the information recording medium of the present invention, the sector number of sectors constituting the ECC block in the recording area of the optical disc, and a recording or reproducing method in an opposite manner of the optical disc.

FIG. 4 is a block diagram of an information recording/reproducing apparatus in an embodiment of an information recording apparatus of the present invention, as well as a host computer.

FIG. 5 is a substantial plan view showing a first offset amount in the optical disc which is the recording object of the information recording/reproducing apparatus in the embodiment of the information recording apparatus of the present invention.

FIG. 6 are a substantial plan view showing a second offset amount (the extent of eccentricity) of the optical disc which is the recording object of the information recording/reproducing apparatus in the embodiment of the information recording apparatus of the present invention (FIG. 6(a)), and a schematic cross sectional view corresponding to the optical disc (FIG. 6(b)).

FIG. 7 is a conceptual diagram schematically showing an aspect in which the first offset amount of a L0 layer and a L1 layer is detected by the information recording/reproducing apparatus in the embodiment of the information recording apparatus of the present invention.

FIG. 8 is a conceptual diagram schematically showing the recording areas before and after the first offset amount of the L0 layer and the L1 layer is added or subtracted by the information recording/reproducing apparatus in the embodiment of the information recording apparatus of the present invention.

FIG. 9 is a conceptual diagram schematically showing that the quality of the record data recorded in the L1 layer varies depending on whether the L0 layer in a comparison example is in the unrecorded condition or the recorded condition.

FIG. 10 is a conceptual diagram schematically showing that light transmittance varies depending on whether the L0 layer in the comparison example is in the unrecorded condition or the recorded condition.

FIG. 11 is a conceptual diagram schematically showing the recording areas on the inner circumferential side before and after the second offset amount is added or subtracted, in addition to the first offset amount of the L0 layer and the L1 layer, by a second recording operation of the information recording/reproducing apparatus in the embodiment of the information recording apparatus of the present invention.

FIG. 12 is a conceptual diagram schematically showing the recording areas on the outer circumferential side before and after the second offset amount is added or subtracted, in addition to the first offset amount of the L0 layer and the L1 layer, by the second recording operation of the information recording/reproducing apparatus in the embodiment of the information recording apparatus of the present invention.

FIG. 13 is a conceptual diagram showing one specific example of a third recording operation in the parallel manner or the opposite manner by the information recording/reproducing apparatus associated with the information recording apparatus of the present invention.

FIG. 14 is a graph showing a difference in position in the radial direction at the same sector number of the L0 layer and the L1 layer, caused by an error in the track pitch of the optical disc which is the recording object of the information recording/reproducing apparatus associated with the information recording apparatus of the present invention.

FIG. 15 is a conceptual diagram showing a recording operation by an information recording/reproducing apparatus in a comparison example, with respect to a two-layer type optical disc with track pitches of the L0 layer and the L1 layer of 0.74 cm.

FIG. 16 is a conceptual diagram showing a recording operation by the information recording/reproducing apparatus in the comparison example, with respect to a two-layer type optical disc with a track pitch of the L0 layer of 0.74 μm and with a track pitch of the L1 layer of 0.75 μm.

FIG. 17 is a conceptual diagram showing another specific example of the third recording operation in the parallel manner of opposite manner by the information recording/reproducing apparatus associated with the information recording apparatus of the present invention.

FIG. 18 are a conceptual diagram schematically showing one recording operation (FIG. 18(a)) and a conceptual diagram schematically showing another recording operation (FIG. 18(b)), in an incremental write method, which is one specific example of the first and second recording operations by the information recording/reproducing apparatus associated with the information recording apparatus of the present invention.

FIG. 19 is a conceptual diagram schematically showing the recording areas on the outer circumferential side, obtained after a buffer area, such as a lead-out area, is formed in the L0 layer, which is another specific example of the first and second recording operations by the information recording/reproducing apparatus associated with the information recording apparatus of the present invention.

### DESCRIPTION OF REFERENCE CODES

100 . . . Optical disc, 101-0 (101-1) . . . Lead-in area, 102-0 (102-1) . . . Data area, 103-0 (103-1) . . . Lead-out area, 104-0 (104-1) . . . Middle area, 300 . . . Information recording/reproducing apparatus, 306 (308) . . . Data input/output control device, 307 . . . Operation control device, 310 . . . Operation button, 311 . . . Display panel, 351 . . . Spindle motor, 352 . . . Optical pickup, 353 . . . Signal recording/reproducing device, 354 . . . CPU (drive control device), 355 (360) . . . Memory, 359 . . . CPU (for host), 400 . . . host computer, LB . . . Laser light

### BEST MODE FOR CARRYING OUT THE INVENTION

Hereinafter, the best mode for carrying out the invention will be explained in each embodiment in order, with reference to the drawings.

(Embodiment of Information Recording Medium)

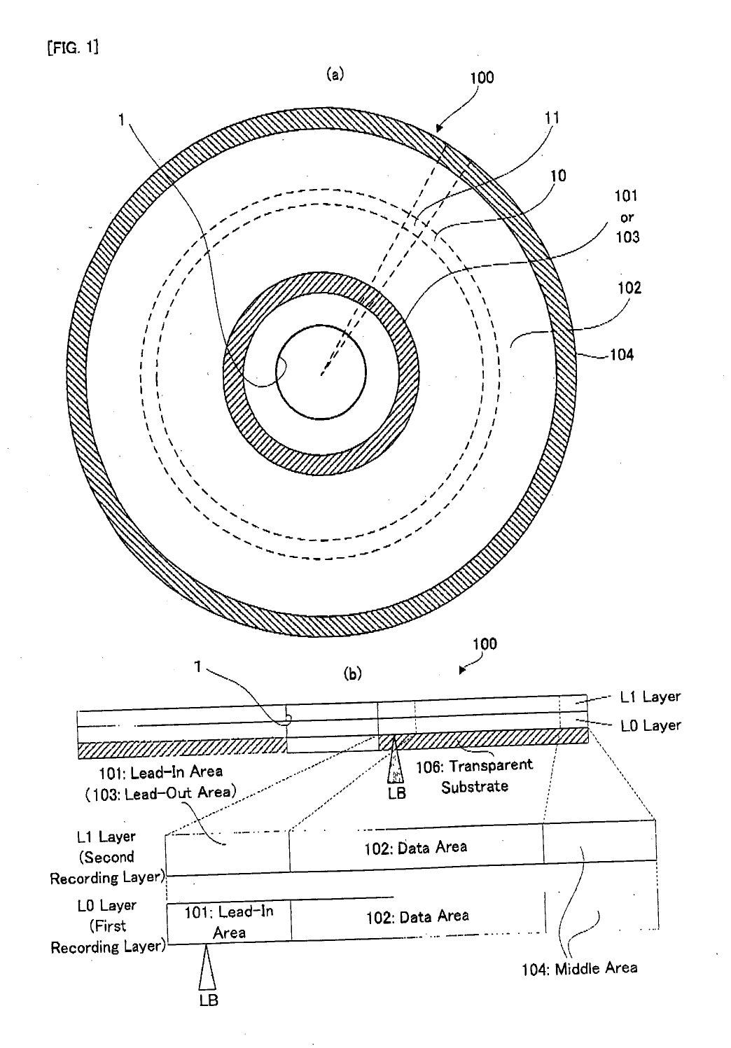

Next, with reference to FIG. 1 to FIG. 3, an embodiment of the information recording medium of the present invention will be explained in detail.

Firstly, the basic structure of an optical disc in the embodiment of the information recording medium of the present invention will be explained with reference to FIG. 1(a) and FIG. 1(b). FIG. 1(a) is a substantial plan view showing the basic structure of an optical disc having a plurality of recording areas in the embodiment of the information recording medium of the present invention, and FIG. 1(b) is a schematic cross sectional view of the optical disc and a corresponding conceptual diagram showing a recording area structure in the radial direction.

As shown in FIG. 1(a) and FIG. 1(b), an optical disc 100 has a recording surface on the disc main body with a diameter of about 12 cm, as is a DVD. On the recording surface, the optical disc 100 is provided with: a lead-in area 101; a data area 102; and a lead-out area 103 or a middle area 104, which are associated with the embodiment, with a center hole 1 as the center. Then, recording layers or the like are laminated on a transparent substrate 106 of the optical disc 100, for example. In each recording area of the recording layers, spirally or concentrically with the center hole 1 as the center, tracks 10, such as groove tracks and land tracks, are placed alternately. Moreover, on the track 10, data is divided by a unit of ECC block 11 and recorded. The ECC block 11 is a data management unit by a pre format address, in which an error in the record information can be corrected.

Incidentally, the present invention is not particularly limited to the optical disc having the three areas as described above. For example, even if the lead-in area 101 and the lead-out area 103 or the middle area 104 do not exist, a data structure explained below can be constructed. Moreover, as described later, the lead-in area 101 and the lead-out area 103 or the middle area 104 may be further segmentized.

Particularly, the optical disc 100 in the embodiment, as shown in FIG. 1(b), has such a structure that a L0 layer and a L1 layer, which constitute one example of the “first and second recording layers” of the present invention as descried later, respectively, are laminated on the transparent substrate 106. Upon the recording and reproduction of such a two-layer type optical disc 100, the recording/reproduction in the L0 layer or the L1 layer is performed, depending on which recording layer is provided with the focusing position of laser light LB, emitted from the upper to the lower side. Moreover, the optical disc 100 in the embodiment is not limited to a two-layer, one side type, i.e., a dual layer, but may be a two-layer double side type, i.e. a dual layer double side. Furthermore, the optical disc 100 in the embodiment is not limited to the optical disc having the two recording layers, as described above, but may be an optical disc of a multi-layer type which has three or more layers.

Incidentally, the recording or reproduction procedure of the two-layer type optical disc in an opposite manner and a parallel manner and the data structure of each layer will be described later.

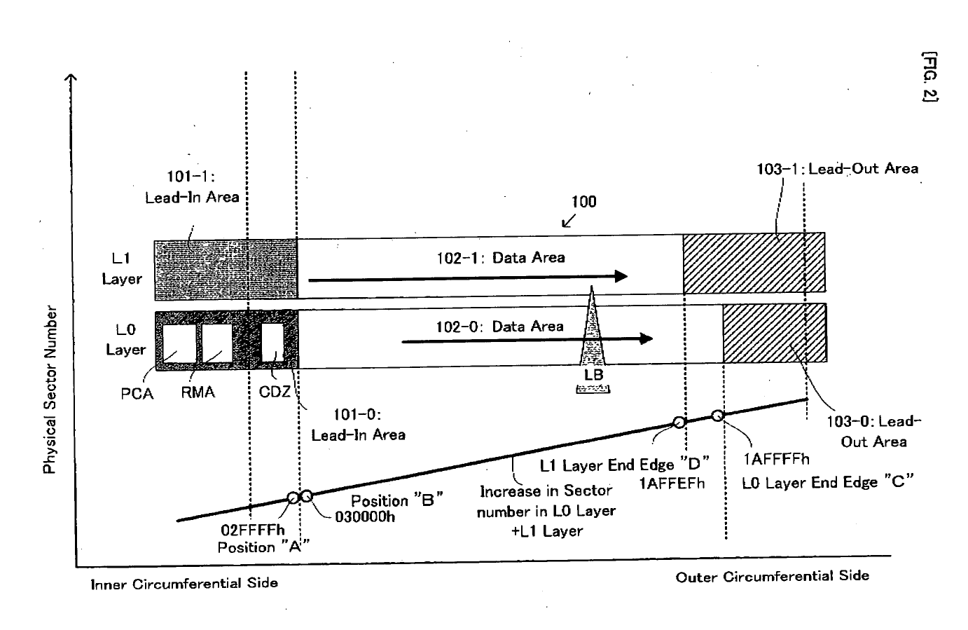

Next, with reference to FIG. 2, the data structure of the two-layer type optical disc in the embodiment of the information recording medium of the present invention, a physical sector number of physical sectors constituting an ECC block in the recording area of the optical disc, a land pre-pit address in the recording area of the optical disc, and the recording or reproduction procedure of the optical disc in the parallel manner will be explained. Here, the physical sector number (hereinafter referred to as a “sector number”, as occasion demands) is position information for indicating an absolute physical address in the recording area of the optical disc. The land pre-pit address (hereinafter referred to as a “LPP address”) is pre-formatted position information corresponding to the sector number. Incidentally, the vertical axis in FIG. 2 indicates the land pre-pit address in addition to the sector number expressed in the hexadecimal notation, and the horizontal axis indicates the relative position in the radial direction of the optical disc.

As shown in FIG. 2, the two-layer type optical disc 100 in the embodiment of the information recording medium of the present invention is provided with two recording layers laminated on a not-illustrated substrate, i.e., the L0 layer and the L1 layer.

Specifically, the L0 layer is provided with: a Power Calibration (PC) area PCA for Optimum Power Calibration (OPC) processing; a Recording Management (RM) area RMA in which recording management information is recorded; a lead-in area 101-0; a data area 102-0; and a lead-out area 103-0, from the inner to the outer circumferential side. The lead-in area 101-0 is provided with a control data zone CDZ, which constitutes one example of the “first, second, or third management area” of the present invention in which the recording management information is recorded.

On the other hand, the L1 layer is provided with: a lead-in area 101-1; a data area 102-1; and a lead-out area 103-1, from the inner to the outer circumferential side. The lead-in area 101-1 may be also provided with a not-illustrated control data zone CDZ and the like.

Since the two-layer type optical disc 100 is constructed in the above manner, upon the recording or reproduction of the optical disc 100, the laser light LB is emitted from the not-illustrated substrate side, i.e. from the lower side in FIG. 2, to the upper side, by a not-illustrated optical pickup of an information recording/reproducing apparatus in an embodiment of the information recording apparatus of the present invention, which will be described later. Moreover, the focus distance and the like are controlled, and the displacement distance and direction in the radial direction of the optical disc 100 are controlled. By this, the data is recorded into each recording layer, or the recorded data is reproduced.

Particularly, the parallel manner may be adopted as the recording or reproduction procedure of the two-layer type optical disc in the embodiment of the information recording medium of the present invention. In the parallel manner, when the recording or reproduction in the L1 layer is started after the recording or reproduction in the L0 layer is finished, the optical pickup that is on the most outer circumference of the optical disc needs to be displaced again to the most inner circumference, so that it takes more time by that much to change from the L0 layer to the L1 layer.

Specifically, firstly, in the L0 layer, as the optical pickup is displaced in the lead-in area 101-0, the data area 102-0, and the lead-out area 103-0, from the inner to the outer circumferential side, the sector number in the recording area of the optical disc 100 increases. More specifically, the optical pickup sequentially accesses the end position of the lead-in area 101-0 with a sector number of “02FFFFh” (refer to a position A in FIG. 2), the start position of the data area 102-0 with a sector number of “030000h” (refer to a position B in FIG. 2), and the end position of the data area 102-0 with a sector number of “1AFFFFh” (refer to a position C in FIG. 2), and is displaced to the lead-out area 103-0 which functions as a buffer. By this, the recording or reproduction in the L0 layer is performed. On the other hand, in the L1 layer, as the optical pickup is displaced in the lead-in area 101-1, the data area 102-1, and the lead-out area 103-1, from the inner to the outer circumferential side, the sector number in the recording area of the optical disc 100 increases. More specifically, the optical pickup sequentially accesses the start position of the lead-in area 101-1 which functions as a buffer, the start position of the data area 102-1 with a sector number of “030000h” (refer to the position B in FIG. 2), and the end position of the data area 102-1 with a sector number of “1AFFEFh” (refer to a position D in FIG. 2), and is displaced to the lead-out area 103-1. By this, the recording or reproduction in the L1 layer is performed.

Thus, content information is recorded or reproduced at the same time of the continuous displacement of the optical pickup from the sector number “030000h” to the sector number “1AFFFFh” of the data area 102-0 in the L0 layer and from the sector number “030000h” to the sector number “1AFFEFh” of the data area 102-1 in the L1 layer.

With respect to the sector number explained above, a Logical Block Address (LBA) is assigned, one to one. More specifically, for example, a LBA of “000000h” corresponds to the sector number of “030000h” in the L0 layer, and a LBA of “17FFFFh” corresponds to the sector number of “1AFFFFh”. On the other hand, a LBA of “18000h” corresponds to the sector number of “030000h” in the L1 layer, and a LBA of “2FFFEFh” corresponds to the sector number of “1AFFEFh”.

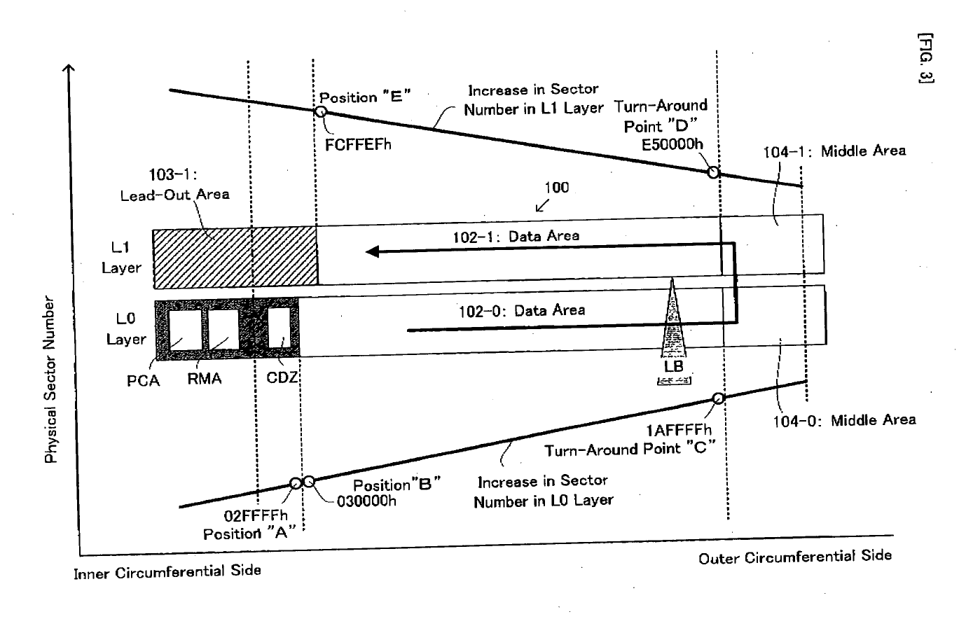

Next, with reference to FIG. 3, the data structure of the two-layer type optical disc in the embodiment of the information recording medium of the present invention, the physical sector number of physical sectors constituting the ECC block in the recording area of the optical disc, and the recording or reproduction procedure of the optical disc in the opposite manner will be explained. FIG. 3 is a conceptual graph schematically showing the data structure of the two-layer type optical disc in the embodiment of the information recording medium of the present invention, the sector number of sectors constituting the ECC block in the recording area of the optical disc, and the recording or reproducing method in the opposite manner of the optical disc. Incidentally, the vertical axis and the horizontal axis and the like in FIG. 3 are the same as those in FIG. 2.

As shown in FIG. 3, the two-layer type optical disc 100 in the embodiment of the information recording medium of the present invention is provided with two recording layers laminated on a not-illustrated substrate, i.e., the L0 layer and the L1 layer.

Specifically, the L0 layer is provided with: a lead-in area 101-0; a data area 102-0; and a middle area 104-0, from the inner to the outer circumferential side. The lead-in area 101-0 is provided with: the PC area; the RM area RMA; and the like.

Specifically, the L0 layer is provided with: the PC area PCA for OPC processing; the RM area RMA in which the recording management information is recorded; the lead-in area 101-0; the data area 102-0; and the middle area 104-0, from the inner to the outer circumferential side. The lead-in area 101-0 may be provided with the control data zone CDZ, which constitutes one example of the “management area” of the present invention described above. Moreover, the middle area 104-0 has a basic function of preventing a record position or a reproduction position for the L0 layer and the L1 layer from being out of the substrate. However, the middle area 104-0 also has a function as a so-called “jump buffer area” which prevents the record position or the reproduction position from being out of the substrate at the time of the layer-to-layer jump.

On the other hand, the L1 layer is provided with: a middle area 104-1; a data area 102-1; and a lead-out area 103-1, from the inner to the outer circumferential side. The lead-out area 103-1 may be also provided with a not-illustrated control data zone CDZ and the like.

Since the two-layer type optical disc 100 is constructed in the above manner, upon the recording or reproduction of the optical disc 100, the focus distance and the like are controlled in the same manner as the parallel manner described above.

Particularly, the opposite manner may be adopted as the recording or reproduction procedure of the two-layer type optical disc in the embodiment of the information recording medium of the present invention. Here, more specifically, the opposite manner is as follows. The recording or reproduction of the two-layer type optical disc is performed in such a manner that the optical pickup of the information recording/reproducing apparatus described later is displaced from the inner to the outer circumferential side in the L0 layer, i.e. in the right direction shown with an arrow in FIG. 3, while, as opposed to the case of the L0 layer, the optical pickup is displaced from the outer to the inner circumferential side in the L1 layer, i.e. in the left direction opposite to an arrow in FIG. 3, as the reproducing or reproduction procedure of the two-layer type optical disc. In the opposite manner, if the recording or reproduction in the L0 layer is finished, when the recording or reproduction in the L1 layer is started, the optical pickup that is on the most outer circumference of the optical disc does not need to be displaced again to the most inner circumference. It is enough if the focus distance is changed from the L0 layer to the L1 layer, so that there is such an advantage that the changing time from the L0 layer to the L1 layer is shorter than that of the parallel manner. Thus, the opposite manner is adopted in the recording of the large-amount content information.

Specifically, firstly, in the L0 layer, as the optical pickup is displaced in the lead-in area 101-0, the data area 102-0, and the middle area 104-0, from the inner to the outer circumferential side, the sector number in the recording area of the optical disc 100 increases. More specifically, the optical pickup sequentially accesses the end position of the lead-in area 101-0 with a sector number of “02FFFFh” (refer to a position A in FIG. 3), the start position of the data area 102-0 with a sector number of “030000h” (refer to a position B in FIG. 3), and the end position of the data area 102-0 with a sector number of “1AFFFFh” (hereinafter referred to as a “turn-around point” in the L0 layer, as occasion demands: refer to a position C in FIG. 3), and is displaced to the middle area 104-0 which functions as a buffer. By this, the recording or reproduction in the L0 layer is performed. Incidentally, in the embodiment, “h” of the “30000h” and the like indicates that the sector number is expressed in the hexadecimal notation. On the other hand, in the L1 layer, as the optical pickup is displaced in the middle area 104-1, the data area 102-1, and the lead-out area 103-1, from the outer to the inner circumferential side, the sector number in the recording area of the optical disc 100 increases. More specifically, the optical pickup sequentially accesses the middle area 104-1 which functions as a buffer, the start position of the data area 102-1 with a sector number of “E50000h” (hereinafter referred to as a “turn-around point” in the L1 layer, as occasion demands: refer to a position D in FIG. 3), and the end position of the data area 102-1 with a sector number of “FCFFEFh” (refer to a position E in FIG. 3), and is displaced to the lead-out area 103-1. By this, the recording or reproduction in the L1 layer is performed.

All the sector numbers in the L0 layer and the L1 layer explained above have a relationship of a 15's complement in the hexadecimal notation. More specifically, the turn-around point in the L0 layer (sector number “1AFFFFh”) and the turn-around point in the L1 layer (sector number “E50000h”) have the relationship of the 15's complement. As a formal matter, the complement of the “1AFFFFh” is obtained by converting the sector number of “1AFFFFh” in the hexadecimal notation to a binary number of “000110101111111111111111”, inverting the bits to “111001010000000000000000”, and reconverting it to the “E50000h” in the hexadecimal notation.

Thus, the content information is recorded or reproduced at the same time of the continuous displacement of the optical pickup from the sector number “030000h” to the sector number “1AFFFFh” of the data area 102-0 in the L0 layer and from the sector number “E50000h” to the sector number “FCFFEFh” of the data area 102-1 in the L1 layer.

With respect to the physical sector number explained above, the Logical Block Address (LBA) is assigned, one to one. More specifically, for example, a LBA of “000000h” corresponds to the sector number of “030000h”, and a LBA of “F9FFEFh” corresponds to the sector number of “FCFFEFh”. Thus, a host computer does not have to be aware of the physical sector number and can perform the recording operation and the reproduction operation in accordance with the logical block address LBA managed by a file system, for example.

(Embodiment of Information Recording Apparatus)

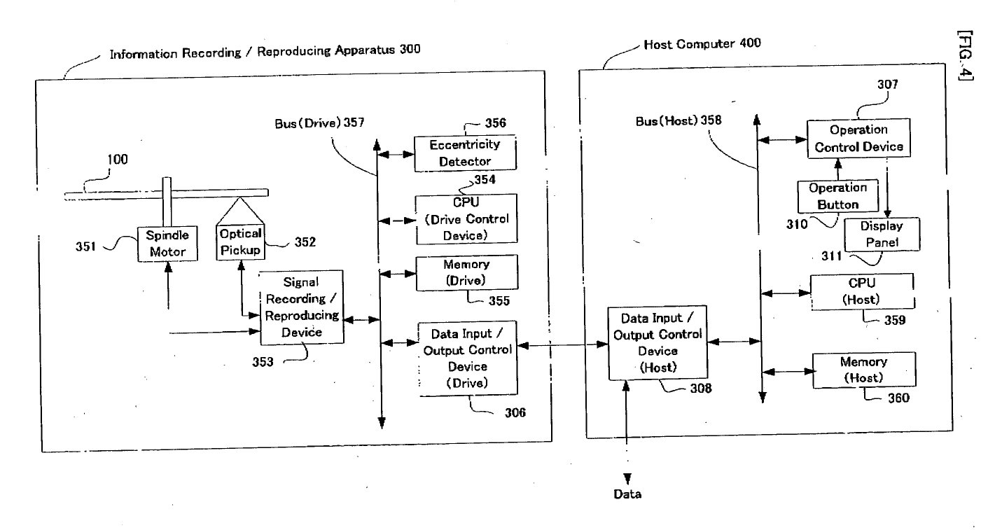

Next, with reference to FIG. 4 to FIG. 19, the structure and operation of the embodiment of the information recording apparatus of the present invention will be explained in detail. Particularly, in the embodiment, the information recording apparatus of the present invention is applied to the information recording/reproducing apparatus for the optical disc.

(1) Basic Structure

Firstly, with reference to FIG. 4, the structures of an information recording/reproducing apparatus 300 and a host computer 400 in the embodiment of the information recording apparatus of the present invention will be explained. FIG. 4 is a block diagram of the information recording/reproducing apparatus in the embodiment of the information recording apparatus of the present invention, as well as the host computer. Incidentally, the information recording/reproducing apparatus 300 has a function of recording the record data onto the optical disc 100 and a function of reproducing the record data recorded on the optical disc 100.

The internal structure of the information recording/reproducing apparatus 300 will be explained with reference to FIG. 4. The information recording/reproducing apparatus 300 is an apparatus for recording the information onto the optical disc 100 and reading the information recorded on the optical disc 100, under the control of a Central Processing Unit (CPU) 354 for a drive.

The information recording/reproducing apparatus 300 is provided with: the optical disc 100; a spindle motor 351; an optical pickup 352; a signal recording/reproducing device 353; the CPU (drive control device) 354; a memory 355; an eccentricity detector 356; a data input/output control device 306; and a bus 357. Moreover, the host computer 400 is provided with: a CPU 359; a memory 360; an operation control device 307; an operation button 310; a display panel 311; and a data input/output control device 308.

Particularly, a communication device may be constructed by including the information recording/reproducing apparatus 300 and the host computer 400 in the same case, or by using the CPU (drive control device) 354, the data input/output control device 306, and the bus 357.

The spindle motor 351 is intended to rotate and stop the optical disc 100, and operates in accessing the optical disc 100. More specifically, the spindle motor 351 is constructed to rotate and stop the optical disc 100 at a predetermined speed while receiving spindle servo by a not-illustrated servo unit or the like.

The optical pickup 352 performs the recording/reproducing with respect to the optical disc 100, and is provided with a semiconductor laser apparatus and a lens. More specifically, the optical pickup 352 irradiates the optical disc 100 with a light beam, such as a laser beam, as reading light with a first power upon reproduction, and as writing light with a second power upon recording, with it modulated.

The signal recording/reproducing device 353 performs the recording/reproducing with respect to the optical disc 100 by controlling the spindle motor 351 and the optical pickup 352. More specifically, the signal recording/reproducing device 353 is provided with a laser diode (LD) driver, a head amplifier, and the like. The LD driver drives the not-illustrated semiconductor laser apparatus built in the optical pickup 352. The head amplifier amplifies the output signal of the optical pickup 352, i.e., the reflected light of the light beam, and outputs the amplified signal. More specifically, the signal recording/reproducing device 353 drives the not-illustrated semiconductor laser apparatus built in the optical pickup 352, so as to determine the optimum laser power by the recording and reproduction process of a n OPC pattern, along with a not-illustrated timing generator, under the control of the CPU 354, in the OPC processing. Particularly, the signal recording/reproducing device 353 constitutes one example of the “writing device” of the present invention, with the optical pickup 352.

The memory 355 is used in the whole data processing and the OPC processing on the information recording/reproducing apparatus 300, including a buffer area for the record/reproduction data, an area used as an intermediate buffer when data is converted into the data that can be used on the signal recording/reproducing device 353, and the like. Moreover, the memory 355 is provided with: a Read Only Memory (ROM) area into which a program for performing an operation as a recording device, i.e., firmware is stored; a buffer for temporarily storing the record/reproduction data; a Random Access Memory (RAM) area into which a parameter required for the operation of the firmware program or the like is stored; and the like.

The CPU (drive control device) 354 is connected to the signal recording/reproducing device 353 and the memory 355 via the bus 357, and controls the entire information recording/reproducing apparatus 300 by giving instructions to various devices. In general, software or firmware for operating the CPU 354 is stored in the memory 355. Particularly, the CPU 354 constitutes one example of the “controlling device” and the “calculating device” of the present invention.

The eccentricity detector 356 can detect an eccentricity on the two-layer type optical disc 100. For example, if the optical disc 100 is produced by pasting the L0 layer and the L1 layer, it is constructed such that it is possible to detect an error in pasting between the center of the L0 layer and the center of the L1 layer. Alternatively, it may be constructed such that it is possible to detect eccentricity caused by the warpage of the optical disc 100 and eccentricity caused by the shift or deviation of the central axis of rotation of the optical disc 100. The “eccentricity” described in the explanation below means eccentricity which occurs on the entire optical disc 100 including the above-described eccentricity, as in the “eccentricity” of the present invention, if not otherwise specified. Particularly, the eccentricity detector 356 constitutes one example of the “detecting device” of the present invention.

The data input/output control device 306 controls the data input/output from the outside with respect to the information recording/reproducing apparatus 300, and stores the data into or extracts it from the data buffer on the memory 355. A drive control command, which is issued from the external host computer 400 (hereinafter referred to as a host, as occasion demands) connected to the information recording/reproducing apparatus 300 via an interface, such as a SCSI (Small Computer System Interface) and an ATAPI (AT Attachment Packet Interface), is transmitted to the CPU 354 through the data input/output control device 306. Moreover, the record/reproduction data is also exchanged with the host computer 400 through the data input/output control device 306.

The operation control device 307 performs the reception of the operation instruction and display with respect to the host computer 400. The operation control device 307 sends the instruction of recording or reproducing by using the operation bottom 310, to the CPU 359. The CPU 359 sends a control command to the information recording/reproducing apparatus 300 through the input/output control device 308 on the basis of the instruction information from the operation control device 307, to thereby control the entire information recording/reproducing apparatus 300. In the same manner, the CPU 359 can send a command of requiring the information recording/reproducing apparatus 300 to send the operation condition to the host, to the information recording/reproducing apparatus 300. By this, it is possible to recognize the operation condition of the information recording/reproducing apparatus 300, such as during recording and during reproduction. Thus, the CPU 359 can output the operation condition of the information recording/reproducing apparatus 300, to the display panel 311, such as a fluorescent tube and a LCD, through the operation control device 307.

One specific example in which the information recording/reproducing apparatus 300 and the host computer 400, as explained above, are used together is household equipment, such as recorder equipment for recording/reproducing a video. The recorder equipment records a video signal from a broadcast reception tuner and an external connection terminal, onto a disc, and outputs the video signal reproduced from the disc, to external display equipment, such as a television. The operation as the recorder equipment is performed by executing a program stored in the memory 360, on the CPU 359. Moreover, in another specific example, the information recording/reproducing apparatus 300 is a disc drive (hereinafter referred to as a drive, as occasion demands), and the host computer 400 is a personal computer or a workstation. The host computer, such as the personal computer, and the drive are connected to each other through the data input/output control devices 306 and 308, such as the SCSI and the ATAPI. An application, such as writing software, which is installed in the host computer, controls the disc drive.

(1) First Recording Operation

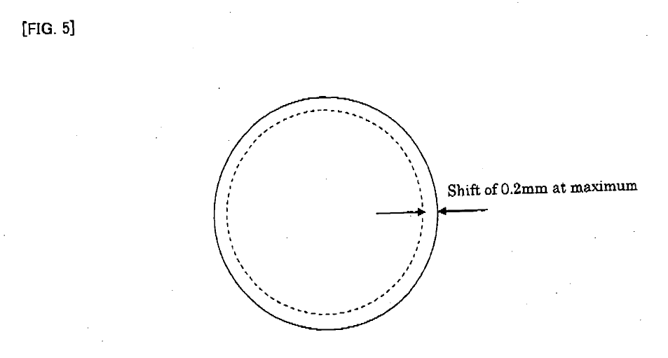

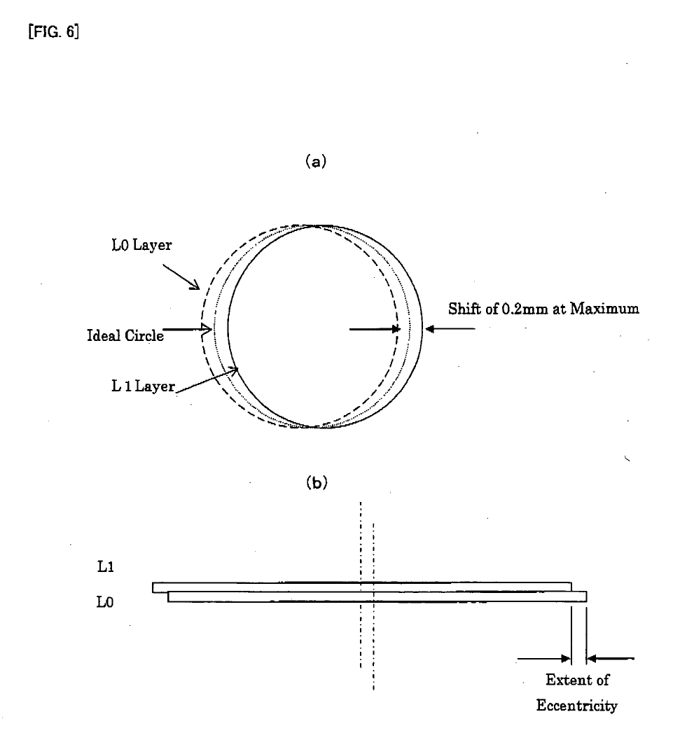

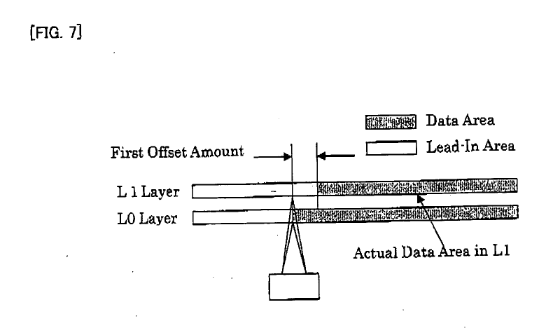

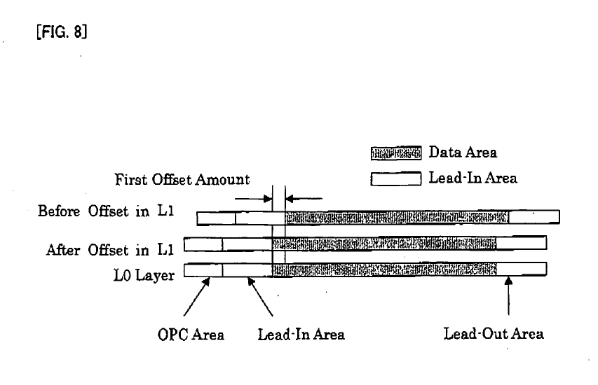

Next, with reference to FIG. 5 to FIG. 8, an explanation will be given on the first recording operation based on a first offset amount of the L0 layer and the L1 layer, by the information recording/reproducing apparatus in the embodiment of the information recording apparatus of the present invention. FIG. 5 is a substantial plan view showing a first offset amount in the optical disc which is the recording object of the information recording/reproducing apparatus in the embodiment of the information recording apparatus of the present invention. FIG. 6 are a substantial plan view showing a second offset amount (the extent of eccentricity) of the optical disc which is the recording object of the information recording/reproducing apparatus in the embodiment of the information recording apparatus of the present invention (FIG. 6(a)), and a schematic cross sectional view corresponding to the optical disc (FIG. 6(b)). FIG. 7 is a conceptual diagram schematically showing an aspect in which the first offset amount of the L0 layer and the L1 layer is detected by the information recording/reproducing apparatus in the embodiment of the information recording apparatus of the present invention. FIG. 8 is a conceptual diagram schematically showing the recording areas before and after the first offset amount of the L0 layer and the L1 layer is added or subtracted by the information recording/reproducing apparatus in the embodiment of the information recording apparatus of the present invention.

According to the first recording operation of the information recording/reproducing apparatus in the embodiment, it is possible to perform the recording operation in the L1 layer, on the basis of the first offset amount. Here, the “first offset amount” is a difference in the radial positions of (i) a place which is the reference of the pre-format address in the L0 layer (e.g. a circumference with the sector number of “30000h” in the L0 layer) and (ii) a place which is the reference of the pre-format address in the L1 layer (e.g. a circumference with the sector number of “30000h” in the L1 layer). More specifically, as shown in FIG. 5, the radial positions of the circumferences with the sector numbers of “30000h” in the L0 layer and the L1 layer are between 11.8 mm and 12.0 mm, due to an error in the diameter of the stamper in the production process. Thus, the maximum value of the first offset amount is 0.2 mm. Moreover, the first offset amount may be constructed by considering the extent of the eccentricity (which is a “second offset amount” described later) caused by the error in pasting in the L0 layer and the L1 layer shown in FIG. 6(a) and FIG. 6(b). More specifically, for example, half of the extent of the eccentricity is added to or is subtracted from the first offset amount. The first offset amount may be shown by the number of sectors or the number of ECC blocks, which are the predetermined unit of the address, or may be shown by the length (μm) in the radial direction of the optical disc and then be possibly converted to the number of sectors and the number of ECC blocks. Moreover, the first offset amount may be shown by a difference in the diameters of the L0 layer and the L1 layer between the diameter of the L0 layer and the diameter of the L1 layer.

Namely, according to the first recording operation of the information recording/reproducing apparatus in the embodiment, by adding only the first offset amount to or subtracting it from the pre-formatted address system in the L1 layer, the recording operation can be performed under a newly defined address system in the L1 layer based on the pre-formatted address system in the L0 layer. Incidentally, the pre-formatted address system is the land pre-pit address in the case of the DVD-R disc, and an Address In Pre-groove (ADIP) in the case of the DVD+R disc, specifically. Moreover, in the embodiment, the first recording operation may be performed on the basis of an address system based on a Radio Frequency (RF) signal recorded later, in addition to the pre-formatted address system. According to the first recording operation of the information recording/reproducing apparatus in the embodiment, at the same time of the first recording operation, the physical or logical address system of the L0 layer is reconstructed on the basis of the physical or logical address system of the L1 layer, so that the recording operation can be performed on this address system.

Specifically, as shown in FIG. 7, at the time of the production of a two-layer type DVD-R optical disc or the like, a pre-writer performs the layer-to-layer jump and detects the first offset amount between the two layers, in pre-recording various control information and management information in one portion of the control data zone CDZ in the L0 layer. Then, the pre-writer records information about the detected first offset amount into the control data zone CDZ, together with the various control information and the like. Incidentally, in a two-layer type DVD+R optical disc or the like, the information recording/reproducing apparatus that performs the recording operation first, plays a role of the pre-writer of the two-layer type DVD-R. Namely, at the first recording of the two-layer type DVD+R optical disc or the like, the information recording/reproducing apparatus detects the above-described first offset amount, and records the information about the detected first offset amount into a session disc control block of the two-layer type DVD+R.

More specifically, the first offset amount is detected as follows. Under the parallel manner, the pre-writer performs the layer-to-layer jump at the head position of the data area 102-0 with the sector number of “30000h” (the LBA of “0000000”) in the L0 layer, and focuses on the L1 layer. Along with the layer-to-layer jump, the sector of the L1 layer is searched for. The pre-writer detects the sector number of the firstly searched sector. For example, if the detected sector number is “2D000h”, it is possible to calculate that the first offset amount is “30000h”−“2D000h”=“03000h”. Incidentally, the first offset amount can be converted to the width of the optical disc in the radial direction on the inner circumferential side of the optical disc (e.g. 0.2 mm). The conversion method can be obtained experimentally, empirically, or theoretically, or by a simulation, for example. Therefore, the pre-writer recognizes that the firstly searched sector is the head position of the data area 102-1 in the L1 layer. With respect to the recognized sector, it is possible to newly assign the sector number of “30000h”, which is obtained by adding only the first offset amount of “03000h” to the pre-formatted sector number (sector number: “2D000h”). In other words, as the LBA, “000000h” can be newly assigned. On the other hand, the pre-writer recognizes the firstly searched sector is the tail position of the data area 102-1 in the L1 layer, under the opposite manner. Incidentally, for example, in the information recording/reproducing apparatus whose recording object is the two-layer type DVD+R optical disc, if the L1 layer is in the unrecorded condition and the sector which is the turn-around point in the middle area is recorded, the first offset may be detected at the sector which is the turn-around point. Then, the pre-writer may recognize that the sector shown by the sector number which is obtained by adding substantially the same recording capacity as that of the L0 layer to the sector number of the turn-around point, is the tail position of the data area 102-1 in the L1 layer. With respect to the recognized sector, it is possible to newly assign the sector number of “FCFFFFh”, which is obtained by subtracting only the first offset amount of “03000h” from the pre-formatted sector number (sector number: “FD2FFFh”). In other words, as the LBA, “D60000h” can be newly assigned.

Moreover, as shown in FIG. 8, under the newly defined address system by the first recording operation of the information recording/reproducing apparatus in the embodiment, only the first offset amount is added to or subtracted from the pre-formatted sector number, for example, which indicates the start or end positions of the lead-in area and the lead-out area which includes the PC (Power Calibration) area PCA, the RM (Recording Management) area RMA, and the control data zone CDZ, in addition to the data area 102-1 in the L1 layer. As described above, it is possible to newly assign the sector number which is obtained by adding only the first offset amount to or subtracting it from the address, such as the pre-formatted sector number, which indicates the start or end position of each recording area.

As described above, according to the first recording operation of the information recording/reproducing apparatus in the embodiment, a search time at the time of the layer-to-layer jump or the layer-to-layer change (a so-called jump performance), is hardly influenced or not influenced at all by the error between the desired address and the actually accessed position, which is caused by the presence of the above-described first offset amount, for example, on the information recording medium, such as the two-layer type optical disc. Namely, the information recording/reproducing apparatus can access the desired address without delay, under the newly defined physical or the logical address system in the L1 layer, based on the pre-formatted address system in the L0 layer. Thus, the information recording/reproducing apparatus hardly delays or does not delay the search time at the time of layer-to-layer jump at all.

Moreover, according to the first recording operation of the information recording/reproducing apparatus in the embodiment, if the record data is alternately recorded in the L0 layer and the L1 layer, when the record data is recorded in the vicinity of the most inner circumferential position or the most outer circumferential position of the data area 102-1 in the L1 layer after the recording of the record data in the L0 layer, it is possible to control the recording operation such that the laser light LB for recording goes through the L0 layer in the recorded condition, without the influence by the error in position caused by the eccentricity in the L0 layer and the L1 layer or the like. Namely, it is possible to record the record data into the L1 layer by the laser light LB emitted through the L0 layer in which the record data is already recorded. Thus, it is possible to properly record the data in the whole data area 102-1 including the vicinity of the most inner circumferential position or the most outer circumferential position of the L1 layer, with the optimum recording laser power obtained in a case where the record data is recorded into the L1 layer through the L0 layer which is in the recorded condition. As a result, it is possible to stabilize reproduction features (e.g. an asymmetry value, a jitter value, degree of modulation, a reproduction error rate, and the like) and obtain good reproduction features even in the case of the reproduction of the record data, which is recorded in the all of the recording areas including the vicinity of the most inner circumferential position or the most outer circumferential position of the user data area 102-1 in the L1 layer. In addition, the recording laser power is not necessarily changed, and the record data may be recorded under the newly defined address system, so that there is such an advantage that the recording operation itself is simplified.

(Study of Operation and Effect of First Recording Operation of Information Recording/Reproducing Apparatus)

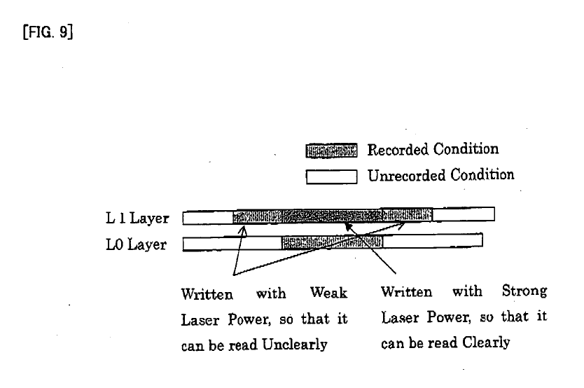

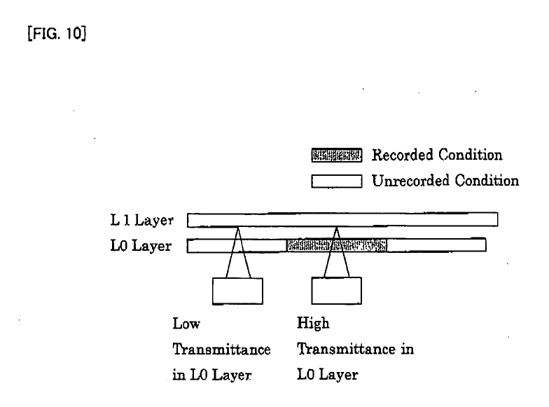

Next, with reference to FIG. 5 and FIG. 6 described above in addition to FIG. 9 and FIG. 10, the operation and effect of the first recording operation of the information recording/reproducing apparatus in the embodiment of the information recording apparatus of the present invention will be studied. Namely, the operation and effect of the recording operation based on the first offset amount of the L0 layer and the L1 layer will be studied. FIG. 9 is a conceptual diagram schematically showing that the quality of the record data recorded in the L1 layer varies depending on whether the L0 layer in a comparison example is in the unrecorded condition or the recorded condition. FIG. 10 is a conceptual diagram schematically showing that light transmittance varies depending on whether the L0 layer in the comparison example is in the unrecorded condition or the recorded condition.

The following two technical problems will be caused, if any consideration is not made in the recording operation with respect to the difference in the radial position between (i) the place which is the reference of the pre-format address in the L0 layer (e.g. the circumference with the sector number of “30000h” in the L0 layer) and (ii) a place which is the reference of the pre-format address in the L1 layer (e.g. the circumference with the sector number of “30000h” in the L1 layer), and with respect to the extent of the eccentricity caused by the error in pasting in the L0 layer and the L1 layer (the “second offset amount” described later), as shown in FIG. 5 and FIG. 6.

The first technical problem is that it is difficult to define the search time at the time of the layer-to-layer jump.

Specifically, according to the study of the inventors of the present invention, it is found that the error between the desired address and the actually accessed position on the two-layer type optical disc is 0.6 mm at maximum. More specifically, the error between the desired address and the actually accessed position, which is caused by the presence of the above-described first offset amount, for example, on the two-layer type optical disc is 0.4 mm, which is twice as much as the maximum value of the first offset amount explained in FIG. 5. Combining this value with 0.2 mm, which is the maximum value of the extent of the eccentricity caused by the error in pasting in the L0 layer and the L1 layer, results in the error of 0.6 mm (=0.4+0.2) between the two layers. In general, in the two-layer type DVD-ROM, the search time at the time of the layer-to-layer jump (the jump performance) is not defined. If the error between the desired address and the actually accessed position on the two-layer type optical disc is 0.6 mm (830 tracks) described above, this causes a difference of about 26600 sectors on the outer circumferential side of the two-layer optical disc. The difference exceeds 20000 sectors which is the maximum value of the jump performance of a single-layer type optical disc in a case where the information recording/reproducing apparatus have the same access performance per unit time of the tracking servo for both the single-layer type optical disc and the two-layer type optical disc, so that the search time is greatly delayed, as compared to the case of the jump performance of the single-layer type optical disc.

As opposed to this, according to the first recording operation of the information recording/reproducing apparatus in the embodiment, the search time at the time of the layer-to-layer jump (the jump performance) is hardly influenced or not influenced at all by the error between the desired address and the actually accessed position, which is caused by the presence of the above-described first and second offset amounts, on the information recording medium, such as the two-layer type optical disc. Namely, the information recording/reproducing apparatus can access the desired address without delay, under the newly defined physical or logical address system in the L1 layer, based on the pre-formatted address system in the L0 layer. Thus, the information recording/reproducing apparatus hardly delays or does not delay the search time at the time of layer-to-layer jump at all.

The second technical problem is as follows. The light transmittance to the L1 layer varies depending on the unrecorded condition or the recorded condition of the L0 layer. So, if the record data is recorded with the laser light emitted in the same condition in the above two cases, even if good recording features are obtained in one case, that does not mean that good recording features are always obtained in the other case.

Specifically, in general, as shown in FIG. 10 or FIG. 9, it is known that the quality of the record data recorded in the L1 layer is different between (i) the case where the record data is recorded into the L1 layer by the laser light emitted through the L0 layer in which the record data is already recorded and (ii) the case where the record data is recorded into the L1 layer by the laser light emitted through the L0 layer in which the record data is unrecorded. More specifically, if the record data is recorded into the L1 layer through the L0 layer which is in the recorded condition, the recording laser power is generally large. Thus, if the recorded record data is reproduced, a reproduction signal tends to be large with respect to a constant reproduction laser power. On the other hand, if the record data is recorded into the L1 layer through the L0 layer which is in the unrecorded condition, the recording laser power is generally small. Thus, if the recorded record data is reproduced, the reproduction signal tends to be small with respect to the constant reproduction laser power. Particularly, this greatly influences the record data recorded in the L1 layer, in the high-speed recording (e.g. 8×-speed or 16×-speed), as compared to the low-speed recording (e.g. 1×-speed or 2×-speed) in which the some extent of margin is allowed in the recording power. This is because, as shown in FIG. 10, the light transmittance to the L1 layer varies depending on the unrecorded condition or the recorded condition of the L0 layer. According to the study of the inventors of the present invention, it is found that the light transmittance to the L1 layer in the L0 layer is about 15% if the L0 layer is in the unrecorded condition, and about 18% if the L0 layer is in the recorded condition. Therefore, there is such a technical problem that if the record data is recorded with the laser light emitted in the same condition in the above two cases, even if good recording features are obtained in one case, that does not mean that good recording features are always obtained in the other case.

As opposed to this, according to the first recording operation of the information recording/reproducing apparatus in the embodiment, if the record data is alternately recorded in the L0 layer and the L1 layer, when the record data is recorded in the vicinity of the most inner circumferential position or the most outer circumferential position of the data area 102-1 in the L1 layer after the recording of the record data in the L0 layer, it is possible to control the recording operation such that the laser light LB for recording goes through the L0 layer in the recorded condition, without the influence by the error in position caused by the eccentricity in the L0 layer and the L1 layer or the like. Namely, it is possible to record the record data into the L1 layer by the laser light LB emitted through the L0 layer in which the record data is already recorded. Thus, it is possible to solve the above-described technical problems. As a result, it is possible to properly record the data in the whole data area 102-1 including the vicinity of the most inner circumferential position or the most outer circumferential position of the L1 layer, with the optimum recording laser power obtained in a case where the record data is recorded into the L1 layer through the L0 layer which is in the recorded condition. As a result, it is possible to stabilize the reproduction features (e.g. an asymmetry value, a jitter value, degree of modulation, a reproduction error rate, and the like) and obtain the good reproduction features even in the case of the reproduction of the record data, which is recorded in the all of the recording areas including the vicinity of the most inner circumferential position or the most outer circumferential position of the user data area 102-1 in the L1 layer. In addition, the recording laser power is not necessarily changed, and the record data may be recorded under the newly defined address system, so that there is such an advantage that the recording operation itself is simplified.

(3) Second Recording Operation

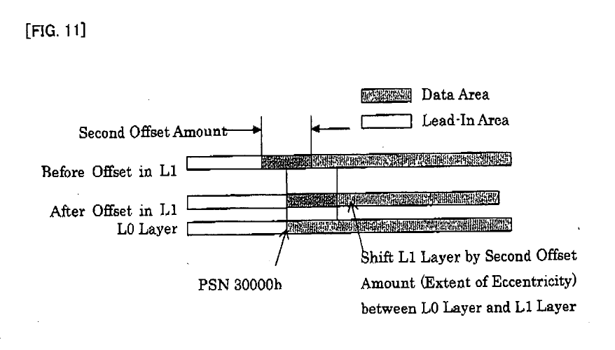

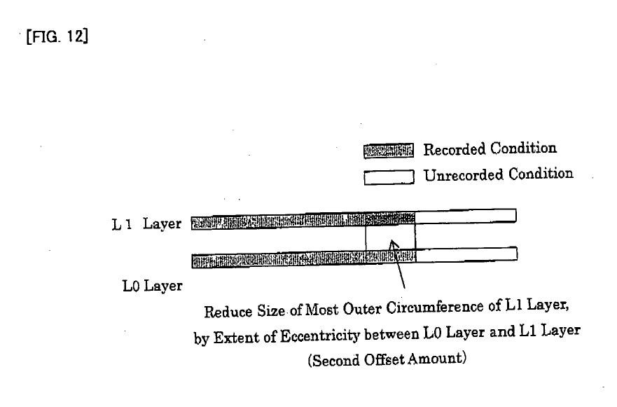

Next, with reference to FIG. 11 and FIG. 12, an explanation will be given on the second recording operation based on the second offset amount in addition to the first offset amount of the L0 layer and the L1 layer, by the information recording/reproducing apparatus in the embodiment of the information recording apparatus of the present invention. FIG. 11 is a conceptual diagram schematically showing the recording areas on the inner circumferential side before and after the second offset amount is added or subtracted, in addition to the first offset amount of the L0 layer and the L1 layer, by a second recording operation of the information recording/reproducing apparatus in the embodiment of the information recording apparatus of the present invention. FIG. 12 is a conceptual diagram schematically showing the recording areas on the outer circumferential side before and after the second offset amount is added or subtracted, in addition to the first offset amount of the L0 layer and the L1 layer, by the second recording operation of the information recording/reproducing apparatus in the embodiment of the information recording apparatus of the present invention.

According to the second recording operation of the information recording/reproducing apparatus in the embodiment, it is possible to perform the recording operation, on the basis of the second offset amount in addition to the first offset amount, by obtaining and referring to the second offset amount in addition to the first offset amount. Here, the “second offset amount” is the extent of the eccentricity caused by the error in pasting in the L0 layer and the L1 layer, as shown in FIG. 6(a) and FIG. 6(b). More specifically, this eccentricity is caused by pasting the first layer and the second layer, a little away from each other, due to the accuracy of a pasting apparatus in the reproduction of the two-layer type optical disc which has a pasted structure. The second offset amount may be shown by the number of sectors or the number of ECC blocks, which are the predetermined unit of the address, or may be shown by the length (μm) in the radial direction of the optical disc and then be possibly converted to the number of sectors and the number of ECC blocks. Incidentally, according to the study of the inventors of the present invention, it is found that the second offset amount is about 0.2 mm at maximum in length in the radial direction, and is “03000h” at maximum if converted to the sector number. Incidentally, the detection of the second offset amount with respect to the two-layer type DVD-R optical disc or the two-layer type DVD+R optical disc, and the recording of the information about the second offset amount onto the recording medium are performed in the same manner as with the first offset amount described above.

Namely, according to the second recording operation of the information recording/reproducing apparatus in the embodiment, by adding only the second offset amount in addition to the first offset amount to or subtracting them from the pre-formatted address system in the L1 layer, the recording operation can be performed under a newly defined address system in the L1 layer based on the pre-formatted address system in the L0 layer. More specifically, as shown in FIG. 11, for example, in the case of the parallel manner, the address system in the L1 layer is newly defined such that the most inner circumferential position of the data area 102-1 in the L1 layer with the sector number of “30000h” is positioned relatively on the outer circumferential side, only by the second offset amount, i.e. only by the extent of the eccentricity, from the most inner circumferential position of the data area 102-0 in the L0 layer with the sector number of “30000h”.

As described above, when the record data is recorded in the vicinity of the most inner circumferential position of the data area 102-1 in the L1 layer, it is possible to control the recording operation such that the laser light LB for recording goes through the L0 layer in the recorded condition, without the influence by the error in position caused by the eccentricity in the L0 layer and the L1 layer or the like.

More specifically, the new address system is defined on the basis of the first offset amount and the second offset amount as follows. As explained in FIG. 7, under the parallel manner, the pre-writer performs the layer-to-layer jump to the L1 layer and performs the search. As a result, if the detected sector number is “2D000h”, it is possible to calculate that the first offset amount is “30000h”−“2D000h”=“03000h”. Incidentally, for convenience of explanation, it is considered that the second offset amount is converted to a sector number of “04000h”. Therefore, the pre-writer recognizes that the head position of the data area 102-1 in the L1 layer is a sector which shifts only by the second offset amount from the detected sector, in a direction from the inner circumferential side to the outer circumferential side. Namely, with respect to the detected sector, it is possible to newly assign a sector number of “2C000h”, which is obtained by adding only the first offset amount of “03000h” to and also subtracting only the second offset amount of “04000h” from the pre-formatted sector number (sector number: “2D000h”). On the other hand, the pre-writer recognizes that the tail position of the data area 102-1 in the L1 layer is a sector which shifts only by the second offset amount from the detected sector, from the inner circumferential side to the outer circumferential side, under the opposite manner. Namely, with respect to the detected sector, it is possible to newly assign a sector number of “FD3FFFh”, which is obtained by subtracting only the first offset amount of “03000h” from and also adding only the second offset amount of “04000h” to the pre-formatted sector number (sector number: “FD2FFFh”). The head position of the data area 102-1 in the L1 layer can be determined by calculating back from the position of the detected sector, and “D90000h” can be newly assigned, for example, instead of the pre-formatted sector number.

Moreover, according to the second recording operation of the information recording/reproducing apparatus in the embodiment, as shown in FIG. 12, the address system in the L1 layer may be newly defined such that the most outer circumferential position of the data area 102-1 in the L1 layer is positioned relatively on the inner circumferential side, only by the second offset amount, i.e. only by the extent of the eccentricity, from the most outer circumferential position of the data area 102-0 in the L0 layer. Then, the recording operation may be performed on this address system with respect to the optical disc.

As described above, when the record data is recorded in the vicinity of the most outer circumferential position of the data area 102-1 in the L1 layer, it is possible to control the recording operation such that the laser light LB for recording goes through the L0 layer in the recorded condition, without the influence by the error in position caused by the eccentricity in the L0 layer and the L1 layer or the like.

(4) Third Recording Operation

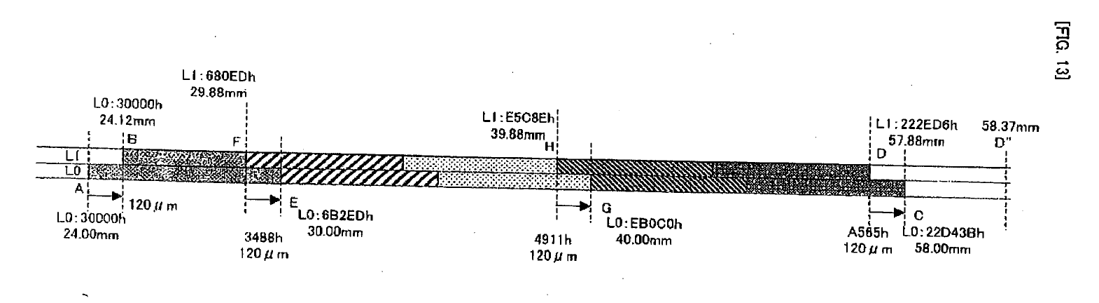

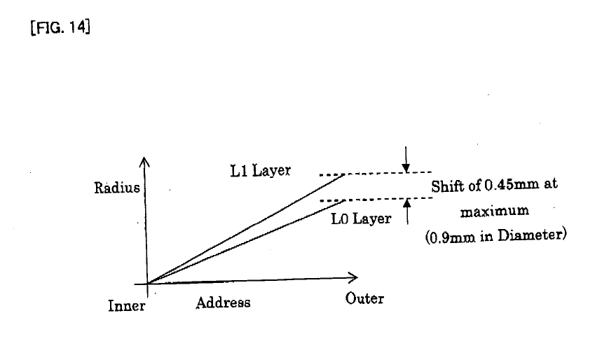

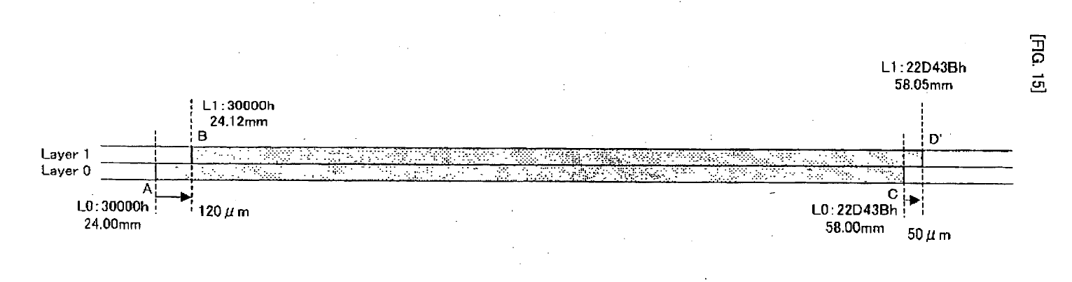

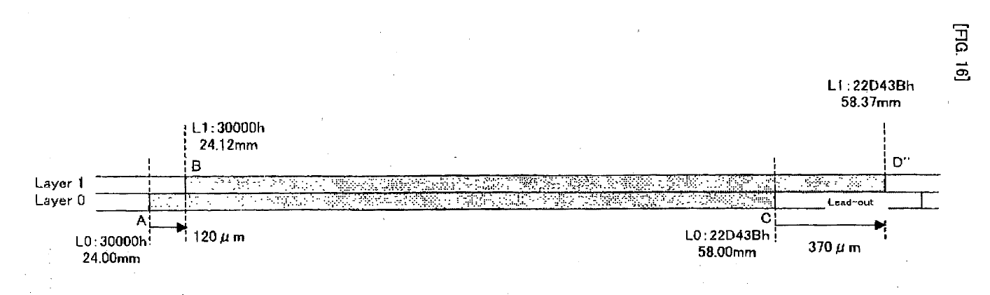

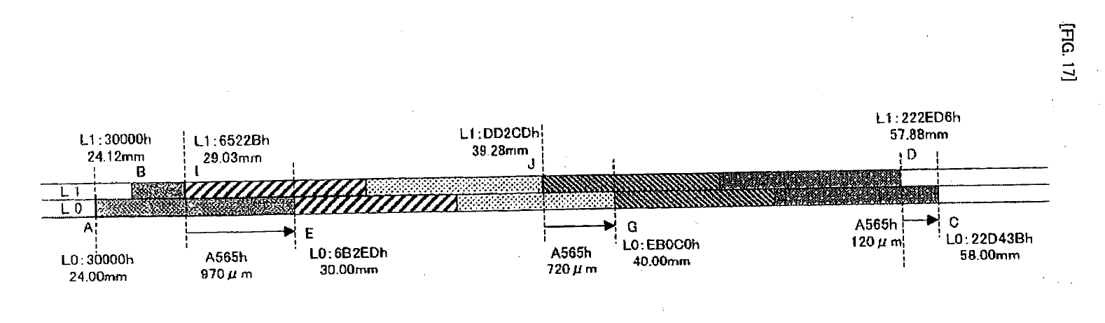

Next, with reference to FIG. 13 to FIG. 17, an explanation will be given on one specific example and another specific example of the third recording operation in the parallel manner and the opposite manner, by the information recording/reproducing apparatus in the embodiment of the information recording apparatus of the present invention, including the study of the operation effect thereof. FIG. 13 is a conceptual diagram showing one specific example of a third recording operation in the parallel manner or the opposite manner by the information recording/reproducing apparatus associated with the information recording apparatus of the present invention. FIG. 14 is a graph showing a difference in position in the radial direction at the same sector number of the L0 layer and the L1 layer, caused by an error in the track pitch of the optical disc which is the recording object of the information recording/reproducing apparatus associated with the information recording apparatus of the present invention. FIG. 15 is a conceptual diagram showing a recording operation by an information recording/reproducing apparatus in a comparison example, with respect to a two-layer type optical disc with track pitches of the L0 layer and the L1 layer of 0.74 μm. FIG. 16 is a conceptual diagram showing a recording operation by the information recording/reproducing apparatus in the comparison example, with respect to a two-layer type optical disc with a track pitch of the L0 layer of 0.74 μm and with a track pitch of the L1 layer of 0.75 cm. FIG. 17 is a conceptual diagram showing another specific example of the third recording operation in the parallel manner of opposite manner by the information recording/reproducing apparatus associated with the information recording apparatus of the present invention.

At first, with reference to FIG. 13 to FIG. 16, an explanation will be given on one specific example of the third recording operation in the parallel manner and the opposite manner by the information recording/reproducing apparatus in the embodiment of the information recording apparatus of the present invention.

As shown in FIG. 13, according to one specific example of the third recording operation in the parallel manner and the opposite manner by the information recording/reproducing apparatus in the embodiment of the information recording apparatus of the present invention, a recording start position B of the data area 102-1 in the L1 layer (sector number: “30000h”, radius 24.12 mm) is positioned on the outer circumferential side, only by the first offset amount (the width in the radial direction is 120 μm), from a recording start position A of the data area 102-0 in the L0 layer (sector number: “30000h”, radius 24.00 mm). Moreover, it is constructed such that after the completion of a series of recording operations with respect to the optical disc in which the record data is alternately recorded in the L0 layer and the L1 layer, a most outer circumferential position D of the data area 102-1 in the L1 layer (sector number: “222ED6h”, radius 57.88 mm) is positioned on the inner circumferential side, only by the second offset amount (the width in the radial direction is 120 μm), from a most outer circumferential position C of the data area 102-0 in the L0 layer (sector number: “22D43Bh”, radius 58.00 mm).

Particularly, according to one specific example of the third recording operation in the parallel manner and the opposite manner by the information recording/reproducing apparatus in the embodiment of the information recording apparatus of the present invention, the recording end position of the data area 102-1 in the L1 layer is always positioned on the inner circumferential side, only by the second offset amount (the width in the radial direction is 120 μm), from the recording end position of the data area 102-0 in the L0 layer, in the recording operation with respect to the optical disc in which the record data is alternately recorded in the L0 layer and the L1 layer. In order to realize this, the actual recording end position of the data area 102-1 in the L1 layer is determined by including the influence by the first offset amount in addition to the second offset amount. Incidentally the determination method can be obtained experimentally, empirically, or theoretically, or by a simulation, for example.

Specifically, as described above, the recording start position B of the data area 102-1 in the L1 layer is positioned on the outer circumferential side, only by the first offset amount (the width in the radial direction is 120 μm), from the recording start position A of the data area 102-0 in the L0 layer. Moreover, as shown in FIG. 14, because it is influenced by (i) the track pitch of the optical disc which is the recording object and (ii) a linear velocity of the optical disc, a difference in position in the radial direction with the same sector number of the L0 layer and the L1 layer is 450 μm (a diameter of 900 μm) at maximum. Therefore, the two factors cause the big difference in position in the radial direction with the same sector number of the L0 layer and the L1 layer. More specifically, as shown in FIG. 15, under the recording operation in which the second offset amount is not considered with respect to the two-layer type optical disc in which the track pitches of the L0 layer and the L1 layer are both 0.74 μm, which is the center of the standard value, a most outer circumferential position D′ of the data area 102-1 in the L1 layer (sector number: “22D43Bh”, radium 58.05 mm) is positioned on the outer circumferential side, by 50 μm in the radial direction, from the most outer circumferential position C of the data area 102-0 in the L0 layer, which has the same sector number as that of the most outer circumferential position D′. In general, since the radius increases as it gets closer to the most outer circumference of the optical disc, the difference in position in the radial direction of the L0 layer and the L1 layer on the most inner circumference, which is the first offset amount (120 μm), decreases to 50 μm on the most outer circumference. Moreover, as shown in FIG. 16, under the recording operation in which the second offset amount is not considered with respect to the two-layer type optical disc in which the track pitch of the L0 layer is 0.74 μm, which is the center of the standard value, and the track pitch of the L1 layer is 0.75 μm, which is the upper limit of the standard value, a most outer circumferential position D″ of the data area 102-1 in the L1 layer (sector number: “22D43Bh”, radium 58.37 mm) is positioned on the outer circumferential side, by 370 μm in the radial direction, from of the most outer circumferential position C of the data area 102-0 in the L0 layer, which has the same sector number as that of the most outer circumferential position D″.

Therefore, again, as shown in FIG. 13, if the track pitch of the L0 layer is 0.74 μm, which is the center of the standard value, and the track pitch of the L1 layer is 0.75 μm, which is the upper limit of the standard value, on the two-layer type optical disc which is the recording object, the recording operation is performed with respect to the optical disc such that the actual most outer circumferential position D of the data area 102-1 in the L1 layer is positioned on the inner circumferential side, by 490 μm (=370+120), from the position D″. In other words, the recording operation is performed with respect to the optical disc such that the sector number of the actual most outer circumferential position D is smaller than that of the position D″, by a sector number of “A565h”. Incidentally, the conversion method of converting from the length in the radial direction to the sector number can be obtained experimentally, empirically, or theoretically, or by a simulation, for example.

In the same manner, for example, the record data which is the first content data is firstly recorded from the recording start position A of the data area 102-0 in the L0 layer to a recording end position E in the L0 layer (sector number: “6B2EDh”, radius: 30.00 mm), in the parallel manner. Then, it is recorded from the recording start position B of the data area 102-1 in the L1 layer to a recording end position F in the L1 layer (sector number: “680EDh”, radius: 29.88 mm) (refer to gray portions in FIG. 13). Thus, a difference of the second offset amount (120 μm) is obtained in the radial direction at the positions E and F. In other words, the recording operation is performed with respect to the optical disc such that the sector number of the recording end position F in the L1 layer is smaller than that of the position E in the L0 layer, only by a sector number of “3488h”. Alternatively, for example, the record data which is the third content data is recorded until a recording end position G in the L0 layer (sector number: “EB0C0h”, radius: 40.00 mm). Then, it is recorded until a recording end position H in the L1 layer (sector number: “E5C8Eh”, radius: 39.88 mm) (refer to dotted portions on a white background in FIG. 13). Thus, a difference of the second offset amount (120 μm) is obtained in the radial direction at the positions G and H. In other words, the recording operation is performed with respect to the optical disc such that the sector number of the recording end position H in the L1 layer is smaller than that of the position G in the L0 layer, only by a sector number of “4911h”.

Incidentally, even in the opposite manner, the recording area will be the same as that in the parallel manner after the completion of the recording operation with respect to the optical disc, so that the explanation will be omitted.

Next, with reference to FIG. 13 in addition to FIG. 17, an explanation will be given on another specific example of the third recording operation in the parallel manner and the opposite manner by the information recording/reproducing apparatus in the embodiment of the information recording apparatus of the present invention.

As shown in FIG. 17, as in substantially the same manner as the one specific example explained in FIG. 13, the recording start position B of the data area 102-1 in the L1 layer is positioned on the outer circumferential side, only by the first offset amount (the width in the radial direction is 120 μm), from the recording start position A of the data area 102-0 in the L0 layer. Moreover, it is constructed such that after the completion of the recording operation with respect to the optical disc in which the record data is alternately recorded in the L0 layer and the L1 layer, the most outer circumferential position D of the data area 102-1 in the L1 layer is positioned on the inner circumferential side, only by the second offset amount (the width in the radial direction is 120 μm), from a most outer circumferential position C of the data area 102-0 in the L0 layer.

Particularly, according to another specific example of the third recording operation in the parallel manner and the opposite manner by the information recording/reproducing apparatus in the embodiment of the information recording apparatus of the present invention, the sector number of the recording end position of the data area 102-1 in the L1 layer is always made smaller than that of the recording end position of the data area 102-0 in the L0 layer, only by the second offset amount (the constant sector number), in the recording operation with respect to the optical disc in which the record data is alternately recorded in the L0 layer and the L1 layer. Incidentally, the determination method of determining the constant sector number which is the second offset amount can be obtained experimentally, empirically, or theoretically, or by a simulation, in substantially the same manner as the one specific example explained in FIG. 13. Moreover, according to another specific example, the record data may be recorded in accordance with the pre-formatted address, such as the sector number, so that there is such an advantage that the recording operation itself is simplified.

More specifically, the recording operation is performed with respect to the optical disc such that the sector number of the actual most outer circumferential position D of the data area 102-1 in the L1 layer is smaller than that of the position C of the data area 102-0 in the L0 layer, by the sector number of “A565h”. As described above, if the constant sector number determined in the most outer circumferential position is the second offset amount, it is obvious that the width in the radial direction corresponding to the constant sector number increases, as it gets close to the inner circumferential side with a smaller radius.

In the same manner, for example, the record data which is the first content data is firstly recorded from the recording start position A of the data area 102-0 in the L0 layer to the recording end position E in the L0 layer, in the parallel manner. Then, it is recorded from the recording start position B of the data area 102-1 in the L1 layer to a recording end position I in the L1 layer (sector number: “6522Bh”, radius: 29.03 mm) (refer to gray portions in FIG. 17). Namely, the recording operation is performed with respect to the optical disc such that the sector number of the recording end position I in the L1 layer is smaller than that of the position E in the L0 layer, only by a sector number of “A565h”. Thus, a difference of 970 μm which is larger than the second offset amount (120 μm) is obtained at the positions E and I in the radial direction. Alternatively, for example, the record data which is the third content data is recorded until the recording end position G in the L0 layer. Then, it is recorded until a recording end position J in the L1 layer (sector number: “DD2CDh”, radius: 39.28 mm) (refer to dotted portions on a white background in FIG. 17). Namely, the recording operation is performed with respect to the optical disc such that the sector number of the recording end position J in the L1 layer is smaller than that of the position G in the L0 layer, only by a sector number of “A565h”. Thus, a difference of 720 μm which is larger than of the second offset amount (120 μm) is obtained in the radial direction at the positions G and J.

Incidentally, even in the opposite manner, the recording area will be the same as that in the parallel manner after the completion of the recording operation with respect to the optical disc, so that the explanation will be omitted.

According to one specific example and another specific example of the third recording operation in the parallel manner and the opposite manner by the information recording/reproducing apparatus in the embodiment of the information recording apparatus of the present invention, if the record data is alternately recorded in the L0 layer and the L1 layer, when the record data is recorded in the data area 102-1 in the L1 layer after the recording of the record data in the L0 layer, it is possible to control the recording operation such that the laser light LB for recording goes through the L0 layer in the recorded condition, without the influence by the error in position caused by the eccentricity in the L0 layer and the L1 layer or the like. Namely, it is possible to record the record data into the L1 layer by the laser light LB emitted through the L0 layer in which the record data is already recorded. Thus, it is possible to properly record the data in the whole data area 102-1 of the L1 layer, with the optimum recording laser power obtained in a case where the record data is recorded into the L1 layer through the L0 layer which is in the recorded condition. As a result, it is possible to stabilize the reproduction features and obtain good reproduction features even in the case of the reproduction of the record data, which is recorded in the all of the recording areas of the L1 layer.

(4) Specific Examples of First and Second Recording Operations

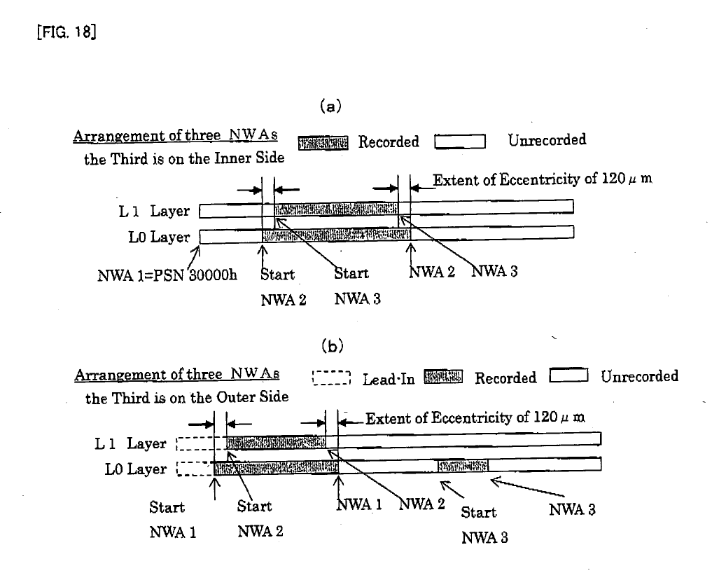

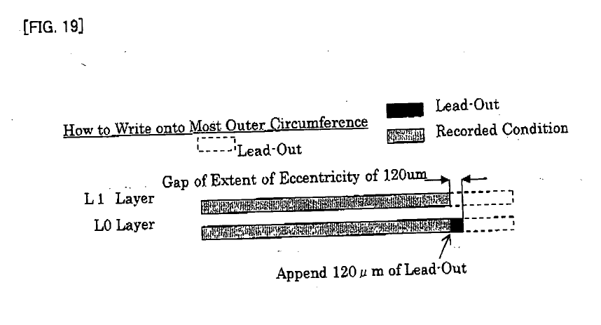

Next, with reference to FIG. 18 and FIG. 19, an explanation will be given on the recording operation in an incremental write method, which is one specific example of the first and second recording operations by the information recording/reproducing apparatus associated with the information recording apparatus of the present invention. FIG. 18 are a conceptual diagram schematically showing one recording operation (FIG. 18(a)) and a conceptual diagram schematically showing another recording operation (FIG. 18(b)), in an incremental write method, which is one specific example of the first and second recording operations by the information recording/reproducing apparatus associated with the information recording apparatus of the present invention. FIG. 19 is a conceptual diagram schematically showing the recording areas on the outer circumferential side, obtained after a buffer area, such as a lead-out area, is formed in the L0 layer, which is another specific example of the first and second recording operations by the information recording/reproducing apparatus associated with the information recording apparatus of the present invention.

As shown in FIG. 18(a), in one recording operation by the incremental write method, if there are provided three groups of Next Writable Addresses (NWAs), each of which indicates a position where a border is additionally recorded, first and second borders are recorded in the L1 layer, and a third border is recorded in the L1 layer, correspondingly to the second border. Particularly, the outer circumferential position of the third border is desirably positioned on the inner circumferential side, only by 120 μm, from the outer circumferential position of the second border. Moreover, in recording of the third border in the L1 layer, it is desirable to record the second border with a width of 0.2 mm or more (corresponding to the second offset amount, i.e., the extent of the eccentricity) in the radial direction in the L0 layer. More specifically, the information recording apparatus detects a difference in the diameter of the L0 layer and the L1 layer, adjusts it, and shifts the position where the LBA is “00000h” in the L1 layer to the outer circumference, only by 120 μm. This 120 μm is obtained by adding a margin of 10 μm to the extent of an eccentricity of 110 μm. Incidentally, the extent of the eccentricity is 40 μm or less in the L0 layer, and 70 μm in the L1 layer. The total of the extent of the eccentricities is desirably 110 μm or less.

As shown in FIG. 18(b), in another recording operation by the incremental write method, a first border is recorded in the L0 layer, and a second border is recorded in the L1 layer, correspondingly to the first border. Particularly, the outer circumferential position of the second border is desirably positioned on the inner circumferential side, only by 120 μm, from the outer circumferential position of the first border. Moreover, in recording of the second border in the L1 layer, it is desirable to record the first border with a width of 0.2 mm or more (corresponding to the second offset amount, i.e., the extent of the eccentricity) in the radial direction in the L0 layer.

As described above, the precondition is that there are three NMAs, i.e., three borders. Thus, once two NMAs, i.e., two borders, which make a pair in the L0 layer and the L1 layer, are formed, it can be said that the recording area of the L1 layer is hardly positioned or is not positioned on the outer circumferential side of the L0 layer at all. In other words, the recording area except the recording area of the NMAs, i.e., borders, which make a pair in the L0 layer and the L1 layer is positioned on the inner or outer circumferential side of the recording area of the L0 layer.

Incidentally, in the alternate recording of the L0 layer and the L1 layer by the incremental write method, the recording may be performed under the other four preconditions. The first precondition is that there is hardly any or no shift or deviation in the linear velocity and the track pitch between the L0 layer and the L1 layer because the stamper is made by using the same machine. Therefore, there is hardly any or no difference in position in the radial direction between the inner circumference of the L0 layer (e.g. a position where the LBA is “000001h”) and the inner circumference of the L1 layer. In the same manner, there is hardly any or no difference in position in the radial direction between the outer circumference of the L0 layer and the outer circumference of the L1 layer. The second precondition is desirably that a tolerance, such as an error in a physical optical system, is the same as or less than that of a two-layer type DVD-ROM. More specifically, it is desirable that the extent of the eccentricity in the L0 layer is 70 μm or less, and that the difference in the diameter between the L0 layer and the L1 layer is 0.5 mm or less on the most outer circumference. The third precondition is desirably that a tolerance, such as the error in the physical optical system, is the same as or less than that of a 4×-speed DVD-R. More specifically, it is desirable that the extent of the eccentricity in the L0 layer is 40 μm or less, and that the difference in the diameter between the L0 layer and the L1 layer is 0.4 mm or less on the inner circumference. In other words, the total of the differences in the radius on the inner circumference in the L0 layer and the L1 layer is desirably 0.2 mm or less. The fourth precondition is desirably that a difference in the light transmittance between the unrecorded recording area and the recorded recording area in the L0 layer is greater than a power margin width of the recording laser power in the L1 layer. There is hardly any or no deviation in the radius of the inner and outer circumferences, however, if there is, it is desirable that the most outer circumferential edge of the L1 layer is positioned from +0 μm to −80 μm, in the radial direction, with respect to the most outer circumferential edge of the L0 layer. Thus, the recording is performed such that the most outer circumferential edge of the L1 layer most is positioned on the inner circumferential side, only by 80 μm, from the most outer circumferential edge of the L0 layer, so that there is no chance that the recording area of the L1 layer is positioned on the outer circumferential side of the recording area of the L0 layer, on the middle circumference and the inner circumference.

As shown in FIG. 19, it is desirable that the a buffer area, such as a lead-out area, is formed such that the most outer circumferential edge of the L0 layer is positioned on the outer circumferential side, only by 120 μm, from the most outer circumferential edge of the L1 layer.

In the embodiment, as one specific example of the information recording medium, for example, the write-once-type or rewritable optical disc, such as a two-layer type DVD-R or DVD+R, or a DVD-RW or DVD+RW, is explained. The present invention, however, can be applied to an optical disc of a multiple-layer type, such as a three-layer type. Moreover, it can be applied to a large-capacity recording medium, such as a disc, in which a blue laser is used for the recording and reproduction. Moreover, as one specific example of the information recording apparatus, for example, the information recording/reproducing apparatus for the write-once-type optical disc, such as the two-layer type DVD-R or DVD+R, is explained. The present invention, however, can be applied to an information recording/reproducing apparatus for the rewritten-type optical disc, such as the two-layer type DVD-R/W or DVD+R/W, for example. In addition, it can be applied to an information recording/reproducing apparatus for the optical disc of a multiple-layer type, such as a three-layer type. Moreover, it can be also applied to an information recording/reproducing apparatus for the large-capacity recording medium, such as a disc, in which a blue laser is used for the recording and reproduction.

The present invention is not limited to the above-described embodiments, and various changes may be made, if desired, without departing from the essence or spirit of the invention which can be read from the claims and the entire specification. An information recording medium, an information recording apparatus, an information recording method, and a computer program, which involve such changes, are also intended to be within the technical scope of the present invention.

### INDUSTRIAL APPLICABILITY

The information recording medium, the information recording apparatus and method, and the computer program according to the present invention can be applied to a high-density recording medium, such as a DVD and a CD, for example, and also applied to an information recording apparatus, such as a DVD recorder. Moreover, they can be applied to an information recording apparatus or the like, which is mounted on or can be connected to various computer equipment for consumer use or business use, for example.

1-23. (canceled)

24. An information recording medium comprising at least:
a first recording layer in a disc shape in which a first recording track is formed to record at least record information; and
a second recording layer in a disc shape in which a second recording track is formed to record the record information through said first recording layer,
said information recording medium comprising a management area in which information as for a first offset amount is recorded, the first offset amount indicating a difference in radial positions of a first place which is a reference of a pre-formatted address in the first recording track and a second place which is a reference of the pre-formatted address in the second recording track.

25. An information recording medium comprising at least:
a first recording layer in a disc shape in which a first recording track is formed to record at least record information; and
a second recording layer in a disc shape in which a second recording track is formed to record the record information through said first recording layer,
said information recording medium comprising a management area in which information as for a third offset amount is recorded, the third offset amount indicating a difference in radial positions of a most outer circumferential position of a recording area of said second recording layer and a most outer circumferential position of a recording area of said first recording layer, the difference being caused by that a track pitch varies in said first recording layer and said second recording layer.

26. An information recording apparatus for recording record information onto an information recording medium comprising: a first recording layer in a disc shape in which a first recording track is formed to record at least record information; and a second recording layer in a disc shape in which a second recording track is formed to record the record information through said first recording layer, at least one of said first and second recording layer comprising a management area in which information as for an offset amount is recorded, the offset amount indicating a relative shift in a radial direction between said first and second recording layers or between the first and second recording tracks,
said information recording apparatus comprising:
a writing device capable of writing the record information into said first recording layer and said second recording layer;
an obtaining device for obtaining the information as for the offset amount;
a calculating device for calculating a start position from which the record information can be recorded, in said second recording layer, on the basis of the obtained information; and
a controlling device for controlling said writing device (i) to write the record information into said first recording layer along the first recording track and (ii) to write the record information into said second recording layer along the second recording track from the calculated start position.

27. The information recording apparatus according to claim 26, further comprising:
a detecting device for detecting the offset amount;
another controlling device for controlling said writing device to write information as for the detected offset amount into the management area along the first or second recording track; and
a calculating device for calculating a start position from which the record information can be recorded, in said second recording layer, on the basis of the detected offset amount,
said controlling device controlling said writing device (i) to write the record information into said first recording layer along the first recording track and (ii) to write the record information into said second recording layer along the second recording track from the calculated start position.

28. The information recording apparatus according to claim 26, wherein
said information recording medium further comprises a data area in which the record information can be recorded from a first start position to a first end position, in at least one of said first and second recording areas,
said calculating device calculates the first start position and the first end position, on the basis of the obtained offset amount, and
said controlling device controls said writing device to write the record information from the first start position to the first end position, along the first or second recording track.

29. The information recording apparatus according to claim 27, wherein
said information recording medium further comprises a data area in which the record information can be recorded from a first start position to a first end position, in at least one of said first and second recording areas,
said calculating device calculates the first start position and the first end position, on the basis of the detected offset amount, and
said controlling device controls said writing device to write the record information from the first start position to the first end position, along the first or second recording track.

30. The information recording apparatus according to claim 28, wherein said calculating device calculates the first start position such that a most inner circumferential position of the data area in said second recording layer is positioned relatively on an outer circumferential side, only by at least the offset amount, from a most inner circumferential position of the data area in said first recording layer.

31. The information recording apparatus according to claim 29, wherein said calculating device calculates the first start position such that a most inner circumferential position of the data area in said second recording layer is positioned relatively on an outer circumferential side, only by at least the offset amount, from a most inner circumferential position of the data area in said first recording layer.

32. The information recording apparatus according to claim 28, wherein said calculating device calculates the first start position such that a most outer circumferential position of the data area in said second recording layer is positioned relatively on an inner circumferential side, only by at least the offset amount, from a most outer circumferential position of the data area in said first recording layer.

33. The information recording apparatus according to claim 29, wherein said calculating device calculates the first start position such that a most outer circumferential position of the data area in said second recording layer is positioned relatively on an inner circumferential side, only by at least the offset amount, from a most outer circumferential position of the data area in said first recording layer.

34. The information recording apparatus according to claim 26, wherein
said information recording medium further comprises a lead-out area in addition to or in place of a lead-in area in which a buffer data as being at least one portion of the record information can be recorded from a second start position to a second end position, in at least one of said first and second recording areas,
said calculating device calculates the second start position and the second end position, on the basis of the obtained offset amount, as the start position, and
said controlling device controls said writing device to write the buffer data from the second start position to the second end position, along the first or second recording track, in response to a finalize instruction with respect to said information recording medium.

35. The information recording apparatus according to claim 27, wherein
said information recording medium further comprises a lead-out area in addition to or in place of a lead-in area in which a buffer data as being at least one portion of the record information can be recorded from a second start position to a second end position, in at least one of said first and second recording areas,
said calculating device calculates the second start position and the second end position, on the basis of the detected offset amount, as the start position, and
said controlling device controls said writing device to write the buffer data from the second start position to the second end position, along the first or second recording track, in response to a finalize instruction with respect to said information recording medium.

36. The information recording apparatus according to claim 26, wherein
said information recording medium further comprises a calibration area in which data for trial writing as being at least one portion of the record information can be recorded from a third start position to a third end position, in at least one of said first and second recording areas, in order to obtain an optimum recording power of laser light for recording,
said calculating device calculates the third start position and the third end position, on the basis of the obtained offset amount, as the start position, and
said controlling device controls said writing device to write the data for trial writing from the third start position to the third end position, along the first or second recording track, in response to an instruction for obtaining the optimum recording laser power with respect to said information recording medium.

37. The information recording apparatus according to claim 27, wherein
said information recording medium further comprises a calibration area in which data for trial writing as being at least one portion of the record information can be recorded from a third start position to a third end position, in at least one of said first and second recording areas, in order to obtain an optimum recording power of laser light for recording,
said calculating device calculates the third start position and the third end position, on the basis of the detected offset amount, as the start position, and
said controlling device controls said writing device to write the data for trial writing from the third start position to the third end position, along the first or second recording track, in response to an instruction for obtaining the optimum recording laser power with respect to said information recording medium.

38. The information recording apparatus according to claim 26, wherein said controlling device controls said writing device, not to write the record information into a recording area of said second recording layer corresponding to a vicinity of a boundary between a recorded area and an unrecorded area of said first recording layer.

39. The information recording apparatus according to claim 26, further comprising:
a detecting device for detecting the offset amount; and
another controlling device for controlling said writing device to write information as for the detected offset amount into the management area along the first or second recording track,
said controlling device controlling said writing device, not to write the record information into a recording area of said second recording layer corresponding to a vicinity of a boundary between a recorded area and an unrecorded area of said first recording layer.

40. An information recording method on an information recording apparatus capable of recording record information onto an information recording medium comprising: a first recording layer in a disc shape in which a first recording track is formed to record at least record information; and a second recording layer in a disc shape in which a second recording track is formed to record the record information through said first recording layer, at least one of said first and second recording layer comprising a management area in which information as for an offset amount is recorded, the offset amount indicating a relative shift in a radial direction between said first and second recording layers or between the first and second recording tracks,
said information recording method comprising:
an obtaining process of obtaining the information as for the offset amount;
a calculating process of calculating a start position from which the record information can be recorded, in said second recording layer, on the basis of the obtained information; and
a writing process of writing the record information (i) into said first recording layer along the first recording track and (ii) into said second recording layer along the second recording track from the calculated start position.

41. A computer program of instructions for tangibly embodying a program of instructions executable by a computer provided in an information recording apparatus to make the computer function as at least one portion of a writing device, an obtaining device, a calculating device, and a controlling device,
said information recording apparatus being for recording record information onto an information recording medium comprising: a first recording layer in a disc shape in which a first recording track is formed to record at least record information; and a second recording layer in a disc shape in which a second recording track is formed to record the record information through said first recording layer, at least one of said first and second recording layer comprising a management area in which information as for an offset amount is recorded, the offset amount indicating a relative shift in a radial direction between said first and second recording layers or between the first and second recording tracks,
said information recording apparatus comprising:
the writing device capable of writing the record information into said first recording layer and said second recording layer;
the obtaining device for obtaining the information as for the offset amount;
the calculating device for calculating a start position from which the record information can be recorded, in said second recording layer, on the basis of the obtained information; and
the controlling device for controlling said writing device (i) to write the record information into said first recording layer along the first recording track and (ii) to write the record information into said second recording layer along the second recording track from the calculated start position.
